(19) United States
(12) Patent Application Publication
(10) Pub. No.: US 2022/0346174 A1
(43) Pub. Date: Oct. 27, 2022

(54) Reporting Listen-before-Talk Failures in a Wireless Network

(71) Applicant: Telefonaktiebolaget LM Ericsson (publ), Stockholm (SE)

(72) Inventors: Min Wang, Luleå (SE); Robert Karlsson, Sundbyberg (SE)

(21) Appl. No.: 17/765,146

(22) PCT Filed: Oct. 1, 2020
(86) PCT No.: PCT/EP2020/077487

§ 371 Date: Mar. 30, 2022

Related U.S. Application Data
(60) Provisional application No. 62/909,872, filed on Oct. 3, 2019.

(51) Int. Cl. H04W 76/18; H04W 76/19; H04W 74/08

(52) U.S. Cl. CPC H04W 76/18; H04W 76/19; H04W 74/0808

(57) ABSTRACT

In one aspect, a method performed by a wireless device is provided. The method comprises transmitting, to a network node, a report message comprising an indication of one or more Listen-Before-Talk (LBT) failures experienced by the wireless device. In another aspect, a method performed by a base station is provided. The method comprises receiving, from a wireless device, a report message comprising an indication of one or more LBT failures experienced by the wireless device.

### TECHNICAL FIELD

Embodiments of the disclosure relate to wireless communication, and particularly provide methods, apparatus and machine-readable media relating to listen-before-talk in wireless networks.

### BACKGROUND

NR in Unlicensed Spectrum (NR-U)

Currently the 5th generation of cellular systems, called New Radio (NR), is being standardized in 3GPP. NR is developed for maximum flexibility to support multiple and substantially different use cases. Besides the typical mobile broadband use case, supported use cases include machine type communication (MTC), ultra-reliable low-latency communications (URLLC), side-link device-to-device (D2D) and several others.

In NR, the basic scheduling unit is called a slot. A slot consists of 14 orthogonal frequency division multiplexing (OFDM) symbols for the normal cyclic prefix configuration. NR supports many different subcarrier spacing configurations and at a subcarrier spacing of 30 kHz the OFDM symbol duration is ˜33 μs. As an example, a slot with 14 symbols for the same subcarrier-spacing is 500 μs long (including cyclic prefixes).

NR also supports flexible bandwidth configurations for different user equipments (UEs) on the same serving cell. In other words, the bandwidth monitored by a UE and used for its control and data channels may be smaller than the carrier bandwidth. One or multiple bandwidth part configurations for each component carrier can be semi-statically signaled to a UE, where a bandwidth part consists of a group of contiguous physical resource blocks (PRBs). Reserved resources can be configured within the bandwidth part. The bandwidth of a bandwidth part is equal to or smaller than the maximal bandwidth capability supported by a UE.

NR is targeting both licensed and unlicensed bands and a work item named NR-based Access to Unlicensed Spectrum (NR-U) was started in January 2019. Allowing unlicensed networks, i.e., networks that operate in shared spectrum (or unlicensed spectrum) to use the available spectrum more effectively is an attractive approach to increasing system capacity. Although unlicensed spectrum does not match the qualities of the licensed regime, solutions that allow an efficient use of it as a complement to licensed deployments have the potential to bring great value to Third Generation Partnership Project (3GPP) operators, and, ultimately, to the 3GPP industry as a whole. It is expected that some features in NR will need to be adapted to comply with the special characteristics of the unlicensed band as well as also different regulations. Subcarrier spacings of 15 or 30 kHz are the most promising candidates for NR-U OFDM numerologies for frequencies below 6 GHz (although the present disclosure is not limited to such subcarrier spacings).

When operating in unlicensed spectrum many regions in the world require a device to sense the medium as free before transmitting. This operation is often referred to as listen-before-talk (LBT). There are many different mechanisms for LBT, depending on which radio technology the device uses and which type of data it wants to transmit. Common to all mechanisms is that the sensing is done in a particular channel (corresponding to a defined carrier frequency) and over a predefined bandwidth. For example, in the 5 GHz band, the sensing is done over 20 MHz channels.

Many devices are capable of transmitting (and receiving) over a wide bandwidth including multiple sub-bands/channels, e.g., LBT sub-band (i.e., the frequency part having a bandwidth equal to the LBT bandwidth). A device is only allowed to transmit on the sub-bands where the medium is sensed as free. Again, there are different ways in which the sensing should be done when multiple sub-bands are involved.

There are at least two ways a device can operate over multiple sub-bands. One way is that the transmitter/receiver bandwidth is changed depending on which sub-bands were sensed as free. In this setup, there is only one component carrier (CC) and the multiple sub-bands are treated as a single channel with a larger bandwidth. The other way is that the device operates almost independent processing chains for each channel. Depending on how independent the processing chains are, this option can be referred to as either carrier aggregation (CA) or dual connectivity (DC).

Channel Access Procedure in NR Unlicensed Spectrum

Listen-before-talk (LBT) is designed for unlicensed spectrum co-existence with other radio access technologies (RATs). In this mechanism, a radio device applies a clear channel assessment (CCA) check (i.e. channel sensing) before any transmission. The transmitter may perform energy detection (ED) over a time period, and compare the detected energy to a threshold (ED threshold) in order to determine if a channel is idle. If the channel is determined to be occupied, the transmitter performs a random back-off within a contention window before the next CCA attempt. In order to protect acknowledgement (ACK) transmissions, the transmitter defers for a period after each busy CCA slot prior to resuming back-off. As soon as the transmitter has grasped access to a channel (e.g., the channel is determined to be free), the transmitter is allowed to perform transmission up to a maximum time duration (namely, the maximum channel occupancy time (MCOT)). For quality-of-service (QoS) differentiation, a channel access priority based on the service type has been defined. For example, four LBT priority classes are defined for differentiation of contention window sizes (CWS) and MCOT between services.

Radio Link Monitoring in LTE and NR Licensed

One of the main intentions of the radio link failure (RLF) procedure in Long Term Evolution (LTE) was to assist the UE to perform a fast and reliable recovery without going via RRC_IDLE. This is beneficial to avoid unnecessary latency owing to the need to perform random access channel (RACH) access and RRC connection establishment from RRC IDLE. Radio link monitoring in LTE is illustrated in FIG. 1.

In LTE, there are several reasons that may lead to radio link failure, including:

1) Timer T310 expiry

While the UE is in RRC connected mode, the UE monitors the downlink radio channel quality based on a downlink reference symbol. The UE compares the measured downlink channel quality with the out-of-sync and in-sync thresholds, Qout and Qin respectively. The physical channel evaluates the downlink channel quality, and periodically sends an indication of out-of-sync or in-sync, to layer 3. The UE layer 3 then evaluates if a radio link failure has occurred based on the in-sync and out-of-sync indications that are output from the layer 3 filter. When the number of consecutively received out-of-sync indications exceeds the value N310, a timer T310 is started. While T310 is running, the radio link is considered to be recovered if the UE consecutively receives N311 in-sync indications from the physical layer.

When the timer T310 expires, a radio link failure is declared by the UE.

2) Maximum number of radio link control (RLC)) retransmissions in uplink is reached

3) Handover failure and timer T304 expiry

During a handover procedure, a timer T304 is started when the UE receives a handover command from the source cell. The value of the timer T304 should be set to allow the UE to perform a maximum number of RACH access attempts to the target cell. When the timer T304 expires without successful establishment of a connection to the target cell, a radio link failure due to handover is detected.

When a radio link failure is triggered, a radio connection re-establishment procedure is triggered. In this procedure, a UE shall first perform cell search to determine the cell for radio link re-establishment. According to 3GPP TS 36.300 v 15.7.0, a UE can select the same cell, a different cell from the same eNodeB (eNB), or a prepared cell from a different eNB, wherein the activity can be resumed (i.e., the UE stays in connected mode) via radio connection re-establishment procedure since the previous UE context can be retrieved by inter-cell communication. However, when a prepared cell is not available, the UE selects an unprepared cell. In this case, the UE has to go to idle mode and try to setup the radio connection afterwards. In this case, activity of the UE cannot be resumed. Table 10.1.6-1 from 3GPP TS 36.300 v 15.7.0 guides the UE behavior for target cell selection.

TABLE 10.1.6-1
Mobility and Radio Link Failure

| Cases | First Phase | Second Phase | T2 expired |
|---|---|---|---|
| UE returns | Continue | Activity is | Go via |
| to the | as if | resumed | RRC_IDLE |
| same cell | no radio | by means of | |
| | problems | explicit signalling | |
| | occurred | between UE and | |
| | | eNB | |
| UE selects | N/A | Activity is | Go via |
| a different | | resumed | RRC_IDLE |
| cell from | | by means of | |
| the same | | explicit signalling | |
| eNB | | between UE and | |
| | | eNB | |
| UE selects | N/A | Activity is | Go via |
| a cell of | | resumed | RRC_IDLE |
| a prepared | | by means of | |
| eNB | | explicit signalling | |
| (NOTE) | | between UE and | |
| | | eNB | |
| UE selects | N/A | Go via | Go via |
| a cell of a | | RRC_IDLE | RRC_IDLE |
| different | | | |
| eNB | | | |
| that is not | | | |
| prepared | | | |
| (NOTE) | | | |

NOTE:
a prepared eNB is an eNB which has admitted the UE during an earlier executed HO preparation phase, or obtains the UE context during the Second Phase.

Beam Failure Recovery Procedure in NR

In NR, the medium access control (MAC) entity may be configured by radio resource control (RRC) with a beam failure recovery procedure which is used for indicating to the serving 5G nodeB (gNB) of a new synchronization signal block (SSB) or channel state information reference signal (CSI-RS) when beam failure is detected on the serving SSB(s)/CSI-RS(s). Beam failure is detected by counting beam failure instance indication from the lower layers to the MAC entity.

The MAC entity shall:

1> if beam failure instance indication has been received from lower layers:

2> start or restart the beamFailureDetectionTimer;

2> increment BFI_COUNTER by 1;

2> if BFI_COUNTER>=beamFailureInstanceMaxCount:

3> if beamFailureRecoveryConfig is configured:

4> start the beamFailureRecoveryTimer, if configured;

4> initiate a Random Access procedure (see subclause 5.1) on the SpCell by applying the parameters powerRampingStep, preambleReceivedTargetPower, and preambleTransMax configured in beamFailureRecoveryConfig.

3> else:

4> initiate a Random Access procedure (see subclause 5.1) on the SpCell.

1> if the beamFailureDetectionTimer expires:

2> set BFI_COUNTER to 0.

1> if the Random Access procedure is successfully completed (see subclause 5.1):

2> stop the beamFailureRecoveryTimer, if configured;

2> consider the Beam Failure Recovery procedure successfully completed.

PUCCH SR Failure Handling Procedure (See 3GPP TS 38.321 v 15.7.0)

A Scheduling Request (SR) is used for requesting uplink shared channel (UL-SCH) resources for a new transmission.

The MAC entity may be configured with zero, one, or more SR configurations. An SR configuration consists of a set of physical uplink control channel (PUCCH) resources for SR across different bandwidth parts (BWPs) and cells. For a logical channel, at most one PUCCH resource for SR is configured per BWP.

Each SR configuration corresponds to one or more logical channels. Each logical channel may be mapped to zero or one SR configuration, which is configured by RRC.

If an SR is triggered and there are no other SRs pending corresponding to the same SR configuration, the MAC entity shall set the SR_COUNTER of the corresponding SR configuration to 0.

When an SR is triggered, it shall be considered as pending until it is cancelled. All pending SR(s) triggered prior to the MAC protocol data unit (PDU) assembly shall be cancelled and each respective sr-ProhibitTimer shall be stopped when the MAC PDU is transmitted and this PDU includes a buffer status report (BSR) MAC control element (CE) which contains buffer status up to (and including) the last event that triggered a BSR prior to the MAC PDU assembly. All pending SR(s) shall be cancelled when the uplink (UL) grant(s) can accommodate all pending data available for transmission.

Only PUCCH resources on a BWP which is active at the time of SR transmission occasion are considered valid.

As long as at least one SR is pending, the MAC entity shall for each pending SR:

1> if the MAC entity has no valid PUCCH resource configured for the pending SR:

2> initiate a Random Access procedure (see subclause 5.1 of TS 38.321 v 15.7.0) on the SpCell and cancel the pending SR.

1> else, for the SR configuration corresponding to the pending SR:

2> when the MAC entity has an SR transmission occasion on the valid PUCCH resource for SR configured; and

2> if sr-ProhibitTimer is not running at the time of the SR transmission occasion; and

2> if the PUCCH resource for the SR transmission occasion does not overlap with a measurement gap; and

2> if the PUCCH resource for the SR transmission occasion does not overlap with a UL-SCH resource:

3> if SR_COUNTER<sr-TransMax:

4> increment SR_COUNTER by 1;

4> instruct the physical layer to signal the SR on one valid PUCCH resource for SR;

4> start the sr-ProhibitTimer.

3> else:

4> notify RRC to release PUCCH for all Serving Cells;

4> notify RRC to release sounding reference signals (SRS) for all Serving Cells;

4> clear any configured downlink assignments and uplink grants;

4> initiate a Random Access procedure (see subclause 5.1 of TS 38.321 v 15.7.0) on the SpCell and cancel all pending SRs.

NOTE: The selection of which valid PUCCH resource for SR to signal SR on when the MAC entity has more than one overlapping valid PUCCH resource for the SR transmission occasion is left to UE implementation.

The MAC entity may stop, if any, ongoing Random Access procedure due to a pending SR which has no valid PUCCH resources configured, which was initiated by MAC entity prior to the MAC PDU assembly. Such a Random Access procedure may be stopped when the MAC PDU is transmitted using a UL grant other than a UL grant provided by Random Access Response, and this PDU includes a BSR MAC CE which contains buffer status up to (and including) the last event that triggered a BSR (see subclause 5.4.5 of TS 38.321 v 15.7.0) prior to the MAC PDU assembly, or when the UL grant(s) can accommodate all pending data available for transmission.

### SUMMARY

There currently exist certain challenge(s).

NR-U is expected to operate in the following deployment scenarios:
Carrier aggregation between licensed band NR (PCell) and NR-U (SCell)
NR-U SCell may have both DL and UL, or DL-only.
Dual connectivity between licensed band LTE (PCell) and NR-U (PSCell)
Stand-alone NR-U
An NR cell with DL in unlicensed band and UL in licensed band
Dual connectivity between licensed band NR (PCell) and NR-U (PSCell)

NR unlicensed operation therefore needs to support both standalone and dual connectivity (DC) scenarios, meaning that both RACH and PUCCH-SR signaling need to be transmitted over unlicensed spectrum cells, since a NR-U cell may operate as a primary cell. At the same time, the radio link monitoring function may be defined by reusing the same mechanism as in NR licensed, where the SSB or CSI-RS can be configured for radio link monitoring (RLM) purpose. Discovery reference signals (DRS) as in LTE license-assisted access (LAA)/enhanced LAA (eLAA)/further enhanced LAA (feLAA) are under discussion in RAN1 on whether/how they shall be also supported for NR-U. Anyway, prior to any uplink or downlink transmission, an LBT operation must be performed in order to grasp access to the channel.

In one case, an NR-U UE may experience consecutive LBT failures during uplink transmissions such as physical random access channel (PRACH), or PUCCH-SR, sounding reference signal or data transmission. In another case, a gNB may experience consecutive LBT failures for downlink (DL) transmissions such as DRS, physical downlink control channel (PDCCH) or data.

A baseline mechanism has been defined for detecting so-called “consistent LBT failure”, with further enhancements not precluded:
A threshold for the number of LBT failures which triggers the “consistent” LBT failure event is defined.
Both a timer and a counter are introduced.
The timer is started/restarted when UL LBT failure occurs.
The counter is reset when the timer expires and incremented when UL LBT failure occurs

However, no mechanism has been specified for reporting such an event to the network.

Certain aspects of the present disclosure and their embodiments may provide solutions to these or other challenges. A reporting mechanism is proposed for LBT failures in an active BWP in unlicensed system. The reporting mechanism may be triggered periodically or based on an event. Upon reception of the reporting message from reporting UEs, the network can better and faster select proper actions for one or more UEs, thus helping UEs which are suffering from LBT failures and/or high channel occupancy to recover from LBT failures.

There are, proposed herein, various embodiments which address one or more of the issues disclosed herein. In a first aspect, there is provided a method performed by a wireless device. The method comprises: transmitting, to a network node, a report message comprising an indication of one or more Listen-Before-Talk, LBT, failures experienced by the wireless device.

In a second aspect, there is provided a method performed by a base station. The method comprises: receiving, from a wireless device, a report message comprising an indication of one or more Listen-Before-Talk, LBT, failures experienced by the wireless device.

Apparatus and machine-readable media for performing the methods of the first and second aspects are also provided.

Certain embodiments may provide one or more technical advantage(s). For example, embodiments of the disclosure may allow the network, e.g. a network node such as an NR-U gNB, to receive relevant information about UE's LBT failure/success statistics as well as about the channel occupancy situation perceived by connected UEs, so that the network can take appropriate and well-founded actions to deal with problematic situations involving high channel occupancy. In some embodiments, a failure report may be triggered earlier than RLF triggering, or a UE may switch to another active BWP without triggering a RLF. In either case, the network is informed of the LBT failures, such that it can take any mitigating action prior to RLF. Usage of a specific report message for LBT failures can achieve greater benefits compared to a pure RRC reestablishment procedure.

The network is able to take better and faster actions in response to detected failures. For example, with accurate report of the reasons for LBT failure, the network may take further actions such as updating radio access network (RAN) configuration for a UE, reconfiguring a group of UEs to save signaling overhead etc. The network can better control the performance of UEs, and better utilize the spectrum available.

### BRIEF DESCRIPTION OF THE DRAWINGS

FIG. 1 is a schematic diagram showing radio link monitoring of a serving cell followed by RRC re-establishment to a target cell;

FIG. 2 is a flowchart of a method performed by a wireless device according to embodiments of the disclosure;

FIG. 3 is a schematic diagram of a virtualization apparatus according to embodiments of the disclosure;

FIG. 4 is a flowchart of a method performed by a network node according to embodiments of the disclosure;

FIG. 5 is a schematic diagram of a virtualization apparatus according to embodiments of the disclosure;

FIG. 6 shows a wireless network in accordance with some embodiments;

FIG. 7 shows a user equipment in accordance with some embodiments;

FIG. 8 shows a virtualization environment in accordance with some embodiments;

FIG. 9 shows a telecommunication network connected via an intermediate network to a host computer in accordance with some embodiments;

FIG. 10 shows a host computer communicating via a base station with a user equipment over a partially wireless connection in accordance with some embodiments;

FIGS. 11 to 14 are flowcharts showing methods implemented in a communication system including a host computer, a base station and a user equipment in accordance with some embodiments.

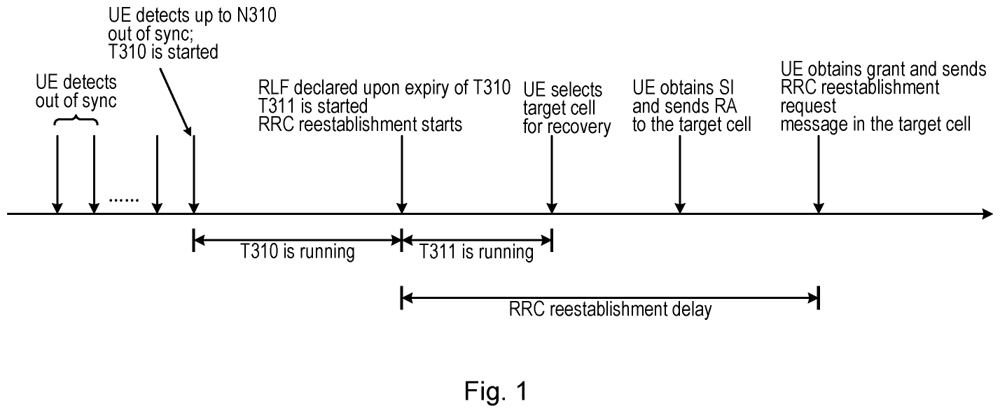

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art. Additional information may also be found in the document(s) provided in the Appendix.

According to embodiments of the disclosure, a UE utilizing unlicensed spectrum (e.g., served by an NR-U system) transmits a report message comprising an indication of one or more LBT failures experienced by the UE to a network node, such as its serving base stations (e.g., gNBs). Multiple reporting mechanisms are proposed, and in some embodiments different reporting mechanisms are provided for different deployment scenarios. Upon reception of the report message from a UE, the network is able to take suitable actions to reconfigure the UE (and/or other UEs who may also suffer from LBT failures). In this way, both latency and signaling overhead can be reduced. The present disclosure is not limited to NR-U, but can be applied in other unlicensed spectrum systems (especially cellular systems) such as LAA/eLAA/feLAA/MulteFire etc.

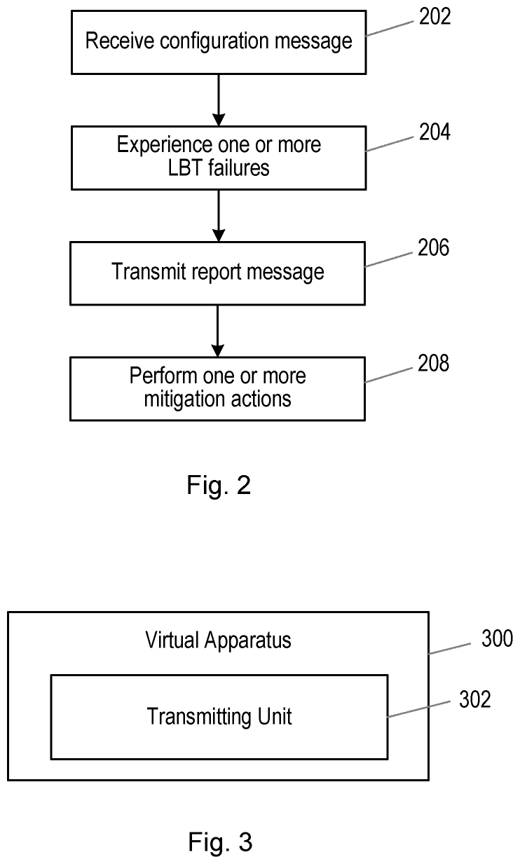

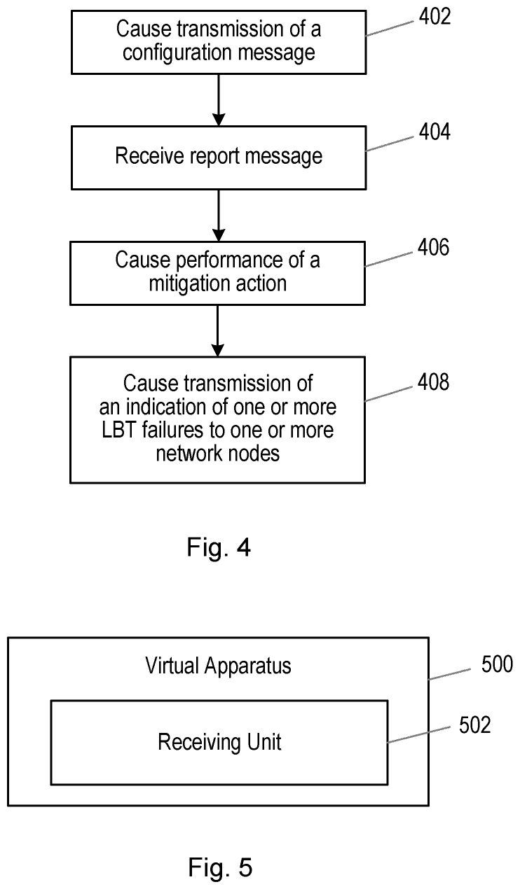

Embodiments of the disclosure will be described in more detail with respect to FIGS. 2 and 4 below, which set out methods performed by a wireless device (e.g., a UE) and a network node (e.g., a base station) respectively.

FIG. 2 depicts a method in accordance with particular embodiments. The method may be performed by a wireless device (e.g., a UE) utilizing unlicensed spectrum. For example, the wireless device may be in communication with a cellular network, such as NR-U, LAA, eLAA, feLAA, MulteFire, etc. The wireless device may correspond to the wireless device 610 or the UE 700 described below.

The method begins at step 202, in which the wireless device receives a configuration message from a network node (e.g., a serving network node such as a base station), comprising an indication of a configuration for the reporting of LBT failures experienced by the wireless device. The network node may correspond to the network node 660 described below.

The configuration message may be transmitted by the network node via dedicated signalling for the wireless device (e.g., via RRC signalling) or broadcast (e.g., via system information). In one embodiment, the wireless device may be provided with multiple configurations for reporting LBT failures, with the network dynamically signalling (e.g., via the configuration message or a further configuration message) an indication of a selected one of the multiple configurations to be used by the wireless device. In the latter case, an indication of the selected configuration may be signalled via DCI or MAC CE based signaling. The configurations for reporting LBT failure may vary between different scenarios, such as between different services accessed by the wireless device; different logical channels or logical channel groups; or different channel access priority classes. Thus the configuration(s) indicated in the configuration message may also be specific to different services accessed by the wireless device; different logical channels or logical channel groups; or different channel access priority classes.

The configuration itself may comprise a configuration of one or more of the following parameters: a trigger for transmitting a report message (e.g., periodic, event-triggered, etc); where transmission of the report message is event-triggered, the details of the trigger event (e.g., a number of detected LBT failures or detected consistent LBT failures, a threshold for channel occupancy, etc); a mechanism for transmitting the report message (e.g., radio resources to be used for transmitting the report message, a physical channel on which the report message should be transmitted, etc); information to be included in the report message (e.g., LBT statistics, requested mitigation actions, etc); one or more mitigation actions to take upon detection of consistent LBT failure, e.g., a preconfigured BWP/cell to switch to.

In step 204, the wireless device experiences one or more LBT failures. Such an LBT failure may occur when the wireless device attempts to grasp access to a channel on unlicensed spectrum, prior to transmitting on that channel. When attempting to grasp access to the channel, the wireless device performs a LBT procedure, which comprises listening to the channel for a period of time prior to transmitting. For example, the wireless device may utilize energy detect (ED) to measure the received energy on the channel, and compare that energy to a threshold to determine whether the channel is free or not. In another example, the wireless device may utilize signal detect (SD) to detect signals by one or more other wireless devices on the channel, and thus determine whether the channel is free or not. In either case, if the channel is not free (i.e., the channel is busy or occupied), the wireless device may backoff for a period of time before re-attempting to grasp access to the channel (and performing a further LBT procedure).

In some embodiments, the wireless device may detect an event known as consistent LBT failure, in which the wireless device experiences a threshold number of LBT failures, typically within a short period of time. Consistent LBT failure may be detected by the wireless device implementing a counter and a timer. The timer is started or restarted upon experiencing a LBT failure. The counter is incremented upon experiencing a LBT failure, and reset when the timer expires. Consistent LBT failure is detected when the counter reaches a threshold value. The effect of this mechanism is to detect consistent LBT failure when the wireless device experiences a threshold number of LBT failures, with each LBT failure occurring within a short time of its immediately preceding LBT failure.

In step 206, the wireless device transmits a report message, to a network node, comprising an indication of one or more LBT failures experienced by the wireless device (e.g., in step 204). In one embodiment, the one or more LBT failures indicated by the wireless device comprise an indication of consistent LBT failure (e.g., as defined above).

The indication may relate to one or more LBT failures experienced on a particular portion or part of the bandwidth of a carrier configured for the wireless device, e.g., a particular bandwidth part. Where the wireless device is configured with multiple such bandwidth parts, the report message may comprise respective indications for LBT failures experienced on each bandwidth part.

The network node to which the report message is transmitted may be a serving network node (e.g., a base station, such as gNB). The network node may be the same network node as that providing the channel on which the LBT failures were experienced, or a different network node. In embodiments where the wireless device received a configuration message in step 202, the transmission of the report message may be in accordance with the configuration indicated by the configuration message.

As noted above, the report message may be transmitted upon detection of a trigger event by the wireless device. For example, the wireless device may experience a threshold number of LBT failures occurring within a time period, or consistent LBT failure (e.g., as defined above), or channel occupancy which exceeds a threshold. The trigger event may be defined or configured so as to occur prior to radio link failure (RLF). For example, where RLF may be detected following a first number of LBT failures, the report message may be triggered after a second number of LBT failures, smaller than the first number. Where RLF may be detected upon channel occupancy meeting a first threshold, the report message may be triggered upon channel occupancy meeting a second threshold, lower than the first threshold.

The report message may be formatted in a number of different ways. For example, in different embodiments of the disclosure, the report message may be conveyed via a transmission on the physical random access channel (PRACH), such as a msg1, msg3 or msgA; alternatively or additionally, the report message may be conveyed via a transmission on an uplink control channel such as the physical uplink control channel (PUCCH); alternatively or additionally, the report message may be formatted in the MAC layer (e.g., as a control element or in a MAC sub-header); alternatively or additionally, the report message may be formatted in the RRC layer (e.g., as a new, dedicated RRC signalling message, or as part of another RRC signalling message).

For example, in one embodiment, dedicated resources (e.g., on a random access channel such as PRACH) are configured for reporting LBT failures. The dedicated resources may comprise one or more of: transmission frequency; time resources (e.g., slots, TTIs, OFDM symbols, etc); random access preambles. By transmitting the report message using the dedicated resources, the network node is informed that the wireless device has experienced LBT failures (e.g., LBT failures meeting the criteria specified in the LBT reporting configuration). In one embodiment, the report message transmitted using the dedicated resources is a random access preamble or msg1 in a random access procedure.

In another embodiment, the report message may be comprised within a different transmission in the random-access procedure, such as Msg3 in a four-step random-access procedure, or in the payload of MsgA in a four-step random-access procedure. In this case, the report message may be transmitted using any suitable resources. The report message may comprise a MAC control element (CE), or a field in the MAC subheader, or an RRC signaling message (e.g., in the Msg3 or MsgA).

A MAC CE may be configured or defined for the purposes of reporting LBT failures. This MAC CE may be a new MAC CE, dedicated for the purposes of reporting LBT failures, or re-use an existing MAC CE. Where a new MAC CE is defined (e.g. called LBT failure/channel occupancy (CO) MAC CE), a new logical channel identity (LCH ID) may be introduced. The new MAC CE may contain no payload bits. In this case, the new MAC CE together with an identifier such as Cell Radio Network Temporary Identifier (C-RNTI) MAC CE will indicate to the network which wireless device has experienced LBT failures.

Alternatively, the report message may comprise RRC signalling, such as a new RRC signalling message introduced for the purposes of reporting LBT failure. The new message may be named for example as “IbtFailure-Info”. Alternatively, the UE may use an existing RRC signaling message to report the occurrence of LBT failures. One or several RRC information elements (IEs) may be introduced accordingly.

As noted above, in another embodiment the report message may be transmitted over a control channel (e.g., PUCCH). In this embodiment, separate control channel resources (e.g., transmission frequency resources and/or time resources) may be allocated for this purpose. Alternatively or additionally, a new PUCCH format may be defined, or an existing PUCCH format used for transmitting the report message. In one example, the report message uses PUCCH scheduling request (SR) signaling combined with transmission using specific PUCCH resources to indicate LBT failure.

Thus in some embodiments, the report message may comprise no information beyond an indication that the wireless device has experienced one or more LBT failures, e.g., where the report message comprises a msg1 or other message transmitted on dedicated resources.

In other embodiments, the report message may comprise additional information, such as one or more of the following:
Indication of the event which triggered transmission of the report message.
Indication that a number of LBT failures has reached a predefined threshold.
Channel occupancy, e.g. based on radio signal strength indicator (RSSI).
LBT statistics, such as one or more of: number of LBT failures and/or successes, LBT failure/success ratio (e.g. calculated or averaged over a certain time period or using exponential averaging of successive time periods), LBT failure rate (e.g. calculated or averaged over a certain time period or using exponential averaging of successive time periods). Any or all of these statistics may be reported per LBT type, per channel access priority class (CAPC), per transmission direction (e.g., UL or DL), per service, per LCH, or per logical channel group (LCG).
One or more radio quality indicators, such as reference signal received power (RSRP), reference signal received quality (RSRQ), RSSI, signal-to-noise ratio (SNR), signal-to-interference-and-noise ratio (SINR), etc.
Service QoS indicators such as latency, packet loss, priority, jitter etc.
Buffer status report.
Power headroom report.
Indications of one or more of the cell(s), bandwidth part(s) (BWPs), carrier(s), channel(s), subband(s) and public land mobile network(s) (PLMNs) on which the LBT failures were experienced, or which suffer from LBT failures or high channel occupancy.
An indication of one or more recovery or mitigation actions that the wireless device would prefer to take place for recovering from or mitigating the LBT failures. The mitigation actions may comprise one or more of: handover to another cell; cell activation, inactivation, addition, release or switch; bandwidth part activation, inactivation, addition, release or switch; carrier activation, inactivation, addition, release or switch; channel activation, inactivation, addition, release or switch; subband activation, inactivation, addition, release or switch; RRC connection establishment; and RRC status switch. Indications (e.g., indices) may also be included for the new cells/BWPs/carriers/channels/subbands to which the wireless device would prefer to be switched.

Where the wireless device is configured with multiple serving cells, the report message may comprise an indication of one or more LBT failures experienced on other cells than the cell on which the report message is sent. For example, where the LBT failures are detected in a serving cell (e.g., an SCell), the UE may report the occurrence of LBT failures in another active serving cell (i.e., a primary cell or another SCell).

In step 208, the wireless device performs one or more mitigating actions. These may be under the instruction of the network node (and may correspond to a preferred mitigation action indicated in the report message), or the autonomous action of the wireless device. For example, the wireless device may switch to a default BWP (or other active BWP if multiple active BWPs are supported) or initiate RRC connection reestablishment in another cell even without waiting for RLF declaration.

It will be noted that, in some embodiments, the reporting of LBT failures may be periodic, or otherwise not triggered by the detection of one or more LBT failures. In this case, a report message for LBT failures may be transmitted regardless of whether or not any LBT failures have been experienced by the wireless device (in this case, the report message may thus comprise an indication that no LBT failures have been experienced by the wireless device).

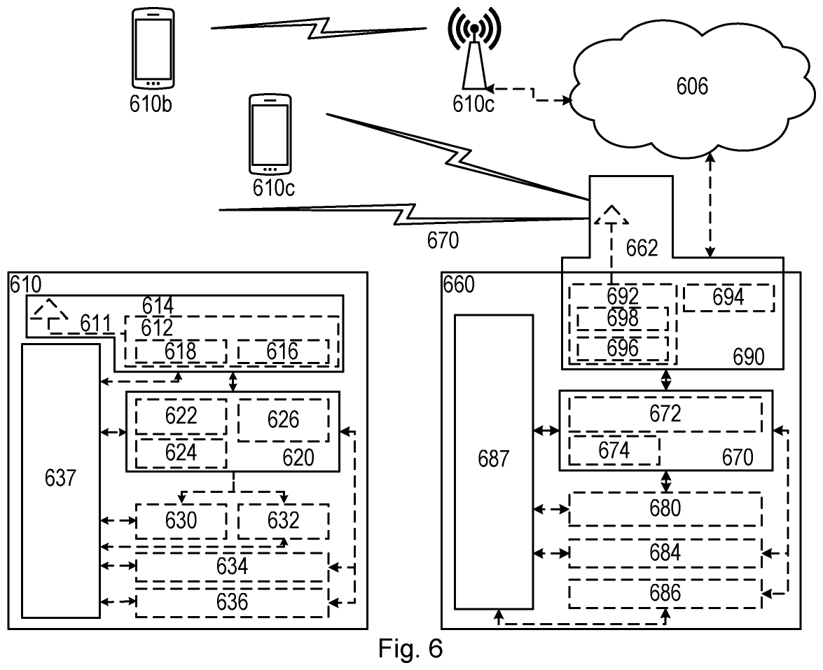

FIG. 3 illustrates a schematic block diagram of an apparatus 300 in a wireless network (for example, the wireless network shown in FIG. 6). The apparatus may be implemented in a wireless device or network node (e.g., wireless device 610 or network node 660 shown in FIG. 6). Apparatus 300 is operable to carry out the example method described with reference to FIG. 2 and possibly any other processes or methods disclosed herein. It is also to be understood that the method of FIG. 2 is not necessarily carried out solely by apparatus 300. At least some operations of the method can be performed by one or more other entities.

Virtual Apparatus 300 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause transmitting unit 302, and any other suitable units of apparatus 300 to perform corresponding functions according one or more embodiments of the present disclosure.

As illustrated in FIG. 3, apparatus 300 includes transmitting unit 302. Transmitting unit 302 is configured to transmit, to a network node, a report message comprising an indication of one or more Listen-Before-Talk (LBT) failures experienced by the wireless device.

FIG. 4 depicts a method in accordance with particular embodiments. The method may be performed by a network node (e.g., a base station, gNB, etc) utilizing unlicensed spectrum. For example, the network node may be implemented in a cellular network, such as NR-U, LAA, eLAA, feLAA, MulteFire, etc. The network node may correspond to the wireless device 660 described below.

The method begins at step 402, in which the network node causes transmission of a configuration message to a wireless device, comprising an indication of a configuration for the reporting of LBT failures experienced by the wireless device. The wireless device may correspond to the wireless device 610 or the UE 700 described below.

The configuration message may be transmitted by the network node via dedicated signalling for the wireless device (e.g., via RRC signalling) or broadcast (e.g., via system information). In one embodiment, the wireless device may be provided with multiple configurations for reporting LBT failures, with the network dynamically signalling (e.g., via the configuration message or a further configuration message) an indication of a selected one of the multiple configurations to be used by the wireless device. In the latter case, an indication of the selected configuration may be signalled via DCI or MAC CE based signaling. The configurations for reporting LBT failure may vary between different scenarios, such as between different services accessed by the wireless device; different logical channels or logical channel groups; or different channel access priority classes. Thus the configuration(s) indicated in the configuration message may also be specific to different services accessed by the wireless device; different logical channels or logical channel groups; or different channel access priority classes.

The configuration itself may comprise a configuration of one or more of the following parameters: a trigger for transmitting a report message (e.g., periodic, event-triggered, etc); where transmission of the report message is event-triggered, the details of the trigger event (e.g., a number of detected LBT failures or detected consistent LBT failures, a threshold for channel occupancy, etc); a mechanism for transmitting the report message (e.g., radio resources to be used for transmitting the report message, a physical channel on which the report message should be transmitted, etc); information to be included in the report message (e.g., LBT statistics, requested mitigation actions, etc); one or more mitigation actions to take upon detection of consistent LBT failure, e.g., a preconfigured BWP/cell to switch to.

In step 404, the network node receives a report message, from the wireless device, comprising an indication of one or more LBT failures experienced by the wireless device. In one embodiment, the one or more LBT failures indicated by the wireless device comprise an indication of consistent LBT failure (e.g., as defined above).

The indication may relate to one or more LBT failures experienced on a particular portion or part of the bandwidth of a carrier configured for the wireless device, e.g., a particular bandwidth part. Where the wireless device is configured with multiple such bandwidth parts, the report message may comprise respective indications for LBT failures experienced on each bandwidth part.

The network node may be the same network node as that providing the channel on which the LBT failures were experienced, or a different network node. In embodiments where the wireless device received a configuration message in step 402, the transmission of the report message may be in accordance with the configuration indicated by the configuration message.

As noted above, the report message may be transmitted upon detection of a trigger event by the wireless device. For example, the wireless device may experience a threshold number of LBT failures occurring within a time period, or consistent LBT failure (e.g., as defined above), or channel occupancy which exceeds a threshold. The trigger event may be defined or configured so as to occur prior to radio link failure (RLF). For example, where RLF may be detected following a first number of LBT failures, the report message may be triggered after a second number of LBT failures, smaller than the first number. Where RLF may be detected upon channel occupancy meeting a first threshold, the report message may be triggered upon channel occupancy meeting a second threshold, lower than the first threshold.

The report message may be formatted in a number of different ways. For example, in different embodiments of the disclosure, the report message may be conveyed via a transmission on the physical random access channel (PRACH), such as a msg1, msg3 or msgA; alternatively or additionally, the report message may be conveyed via a transmission on an uplink control channel such as the physical uplink control channel (PUCCH); alternatively or additionally, the report message may be formatted in the MAC layer (e.g., as a control element or in a MAC sub-header); alternatively or additionally, the report message may be formatted in the RRC layer (e.g., as a new, dedicated RRC signalling message, or as part of another RRC signalling message).

For example, in one embodiment, dedicated resources (e.g., on a random access channel such as PRACH) are configured for reporting LBT failures. The dedicated resources may comprise one or more of: transmission frequency; time resources (e.g., slots, TTIs, OFDM symbols, etc); random access preambles. By transmitting the report message using the dedicated resources, the network node is informed that the wireless device has experienced LBT failures (e.g., LBT failures meeting the criteria specified in the LBT reporting configuration). In one embodiment, the report message transmitted using the dedicated resources is a random access preamble or msg1 in a random access procedure.

In another embodiment, the report message may be comprised within a different transmission in the random-access procedure, such as Msg3 in a four-step random-access procedure, or in the payload of MsgA in a four-step random-access procedure. In this case, the report message may be transmitted using any suitable resources. The report message may comprise a MAC control element (CE), or a field in the MAC subheader, or an RRC signaling message (e.g., in the Msg3 or MsgA).

A MAC CE may be configured or defined for the purposes of reporting LBT failures. This MAC CE may be a new MAC CE, dedicated for the purposes of reporting LBT failures, or re-use an existing MAC CE. Where a new MAC CE is defined (e.g. called LBT failure/CO MAC CE), a new logical channel identity (LCH ID) may be introduced. The new MAC CE may contain no payload bits. In this case, the new MAC CE together with an identifier such as Cell Radio Network Temporary Identifier (C-RNTI) MAC CE will indicate to the network which wireless device has experienced LBT failures.

Alternatively, the report message may comprise RRC signalling, such as a new RRC signalling message introduced for the purposes of reporting LBT failure. The new message may be named for example as “IbtFailure-Info”. Alternatively, the UE may use an existing RRC signaling message to report the occurrence of LBT failures. One or several RRC information elements (IEs) may be introduced accordingly.

As noted above, in another embodiment the report message may be transmitted over a control channel (e.g., PUCCH). In this embodiment, separate control channel resources (e.g., transmission frequency resources and/or time resources) may be allocated for this purpose. Alternatively or additionally, a new PUCCH format may be defined, or an existing PUCCH format used for transmitting the report message. In one example, the report message uses PUCCH scheduling request (SR) signaling combined with transmission using specific PUCCH resources to indicate LBT failure.

Thus in some embodiments, the report message may comprise no information beyond an indication that the wireless device has experienced one or more LBT failures, e.g., where the report message comprises a msg1 or other message transmitted on dedicated resources.

In other embodiments, the report message may comprise additional information, such as one or more of the following:
Indication of the event which triggered transmission of the report message.
Indication that a number of LBT failures has reached a predefined threshold.
Channel occupancy, e.g. based on RSSI.
LBT statistics, such as one or more of: number of LBT failures and/or successes, LBT failure/success ratio (e.g. calculated or averaged over a certain time period or using exponential averaging of successive time periods), LBT failure rate (e.g. calculated or averaged over a certain time period or using exponential averaging of successive time periods). Any or all of these statistics may be reported per LBT type, per CAPC, per transmission direction (e.g., UL or DL), per service, per LCH, or per LCG.
One or more radio quality indicators, such as RSRP, RSRQ, RSSI, SNR, SINR, etc.
Service QoS indicators such as latency, packet loss, priority, jitter etc.
Buffer status report.
Power headroom report.
Indications of one or more of the cell(s), bandwidth part(s) (BWPs), carrier(s), channel(s), subband(s) and PLMN(s) on which the LBT failures were experienced, or which suffer from LBT failures or high channel occupancy.
An indication of one or more recovery or mitigation actions that the wireless device would prefer to take place for recovering from or mitigating the LBT failures. The mitigation actions may comprise one or more of: handover to another cell; cell activation, inactivation, addition, release or switch; bandwidth part activation, inactivation, addition, release or switch; carrier activation, inactivation, addition, release or switch; channel activation, inactivation, addition, release or switch; subband activation, inactivation, addition, release or switch; RRC connection establishment; and RRC status switch. Indications (e.g., indices) may also be included for the new cells/BWPs/carriers/channels/subbands to which the wireless device would prefer to be switched.

Where the wireless device is configured with multiple serving cells, the report message may comprise an indication of one or more LBT failures experienced on other cells than the cell on which the report message is sent. For example, where the LBT failures are detected in a serving cell (e.g., an SCell), the UE may report the occurrence of LBT failures in another active serving cell (i.e., a primary cell or another SCell).

It will be noted that, in some embodiments, the reporting of LBT failures may be periodic, or otherwise not triggered by the detection of one or more LBT failures. In this case, a report message for LBT failures may be received regardless of whether or not any LBT failures have been experienced by the wireless device (in this case, the report message may thus comprise an indication that no LBT failures have been experienced by the wireless device).

In step 406, the network node causes performance of one or more mitigating actions, to mitigate the LBT failures or high channel occupancy experienced by the wireless device. For example, the network node may transmit an instruction to the wireless device, to another network node (e.g., in the radio access network) and/or to a core network node to perform the mitigation action. The mitigation action may correspond to a preferred mitigation action indicated in the report message, or another mitigation action.

According to embodiments of the disclosure, the mitigation actions may comprise one or more of the following:
1) Handover UE(s) to other cell(s) with low channel occupancy/congestion/LBT failure ratio, where the wireless device will have higher probabilities of successful LBT.
2) Switch the wireless device to other BWP(s) with low channel occupancy/congestion/LBT failure ratio, where the UE(s) will have higher probabilities of successful LBT.
3) Switch the wireless device from one serving carrier to another carrier with low channel occupancy/congestion/LBT failure ratio, where the UE(s) will have better possibilities of successful LBT.
4) Switch the wireless device from one serving channel/subband to one or more other channel(s)/subband(s) with low channel occupancy/congestion/LBT failure ratio, where the UE(s) will have higher probabilities of successful LBT.
5) Perform reconfiguration of specific RAN functions such as PUCCH, PDCCH, RACH, discontinuous reception (DRX), SRS configuration, timing advance configuration or data transmission related functions etc.
6) Perform reconfiguration of RLF declaration/triggering conditions.
7) Change the RRC status of the wireless device.
8) Increase or decrease the scheduling rate or change the scheduling priority of the wireless device.
9) Increase the size of the transport block scheduled in UL grants, so that the wireless device can transmit more data once they manage to transmit, i.e. when LBT succeeds.
10) Switch operating band for a cell, possibly handing over all UEs on that cell to other cells. That is, stopping the use of a band that is severely affected by interference or problems to access the channel.
11) Configure the wireless device with prepared actions in case it detects consistent LBT failures

In some embodiments, the one or more mitigation actions may be performed for a group of wireless devices (e.g., a plurality of wireless devices), to which the wireless device belongs. The wireless devices may be grouped according to one or more of the following criteria:
1) Belonging to the same serving cell/carrier/active BWP/channel/subband/beam/group of beams/sector as the reporting wireless device.
2) Have the same UE category/capabilities as the wireless device.
3) Carrying services with similar QoS requirements as the reporting wireless device. This may be augmented, e.g. by information about the UE's traffic pattern, e.g. the information carried in the Additional QoS Flow Information IE in the Initial Context Setup Request NGAP message in NR and/or the information contained in the Expected UE Behaviour IE in the Initial Context Setup Request S1AP message in LTE.
4) Having similar traffic pattern/characteristics, e.g. in terms of the rate of “produced” uplink data and how frequently the wireless device attempts to transmit.
5) Wireless devices having sent an LBT/CO statistics report indicating high channel occupancy or high LBT failure fraction.
6) Wireless devices which have failed to transmit data on allocated UL grants, e.g. at least a certain number of times during a given period or at least at a certain rate or fraction of all their/its UL grants, etc.

Thus the mitigation action may be performed for all wireless devices (i.e., in the group) which are experiencing, or which are likely to experience, LBT failures.

In step 408, the network node causes transmission, to one or more other network nodes, of an indication of the one or more LBT failures reported to it in step 404. Note that step 408 may take place at the same time or earlier than step 406. The one or more other network nodes may include radio access network nodes, such as those which neighbour the network node performing the method shown in FIG. 4. The indication may be transmitted over a direct interface between the network nodes, such as an X2 interface.

In this way, neighbouring network nodes are enabled to take the same or similar mitigation actions as performed by the network node e.g., in step 406).

FIG. 5 illustrates a schematic block diagram of an apparatus 500 in a wireless network (for example, the wireless network shown in FIG. 6). The apparatus may be implemented in a wireless device or network node (e.g., wireless device 610 or network node 660 shown in FIG. 6). Apparatus 500 is operable to carry out the example method described with reference to FIG. 4 and possibly any other processes or methods disclosed herein. It is also to be understood that the method of FIG. 4 is not necessarily carried out solely by apparatus 500. At least some operations of the method can be performed by one or more other entities.

Virtual Apparatus 500 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause receiving unit 502, and any other suitable units of apparatus 500 to perform corresponding functions according one or more embodiments of the present disclosure.

As illustrated in FIG. 5, apparatus 500 includes receiving unit 502. Receiving unit 502 is configured to receive, from a wireless device, a report message comprising an indication of one or more Listen-Before-Talk (LBT) failures experienced by the wireless device.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Although the subject matter described herein may be implemented in any appropriate type of system using any suitable components, the embodiments disclosed herein are described in relation to a wireless network, such as the example wireless network illustrated in FIG. 6. For simplicity, the wireless network of FIG. 6 only depicts network 606, network nodes 660 and 660b, and WDs 610, 610b, and 610c. In practice, a wireless network may further include any additional elements suitable to support communication between wireless devices or between a wireless device and another communication device, such as a landline telephone, a service provider, or any other network node or end device. Of the illustrated components, network node 660 and wireless device (WD) 610 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 606 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 660 and WD 610 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 6, network node 660 includes processing circuitry 670, device readable medium 680, interface 690, auxiliary equipment 684, power source 686, power circuitry 687, and antenna 662. Although network node 660 illustrated in the example wireless network of FIG. 6 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 660 are depicted as single boxes located within a larger box, or nested within multiple boxes, in practice, a network node may comprise multiple different physical components that make up a single illustrated component (e.g., device readable medium 680 may comprise multiple separate hard drives as well as multiple RAM modules).

Similarly, network node 660 may be composed of multiple physically separate components (e.g., a NodeB component and a RNC component, or a BTS component and a BSC component, etc.), which may each have their own respective components. In certain scenarios in which network node 660 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 660 may be configured to support multiple radio access technologies (RATs). In such embodiments, some components may be duplicated (e.g., separate device readable medium 680 for the different RATs) and some components may be reused (e.g., the same antenna 662 may be shared by the RATs). Network node 660 may also include multiple sets of the various illustrated components for different wireless technologies integrated into network node 660, such as, for example, GSM, WCDMA, LTE, NR, WiFi, or Bluetooth wireless technologies. These wireless technologies may be integrated into the same or different chip or set of chips and other components within network node 660.

Processing circuitry 670 is configured to perform any determining, calculating, or similar operations (e.g., certain obtaining operations) described herein as being provided by a network node. These operations performed by processing circuitry 670 may include processing information obtained by processing circuitry 670 by, for example, converting the obtained information into other information, comparing the obtained information or converted information to information stored in the network node, and/or performing one or more operations based on the obtained information or converted information, and as a result of said processing making a determination.

Processing circuitry 670 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 660 components, such as device readable medium 680, network node 660 functionality. For example, processing circuitry 670 may execute instructions stored in device readable medium 680 or in memory within processing circuitry 670. Such functionality may include providing any of the various wireless features, functions, or benefits discussed herein. In some embodiments, processing circuitry 670 may include a system on a chip (SOC).

In some embodiments, processing circuitry 670 may include one or more of radio frequency (RF) transceiver circuitry 672 and baseband processing circuitry 674. In some embodiments, radio frequency (RF) transceiver circuitry 672 and baseband processing circuitry 674 may be on separate chips (or sets of chips), boards, or units, such as radio units and digital units. In alternative embodiments, part or all of RF transceiver circuitry 672 and baseband processing circuitry 674 may be on the same chip or set of chips, boards, or units

In certain embodiments, some or all of the functionality described herein as being provided by a network node, base station, eNB or other such network device may be performed by processing circuitry 670 executing instructions stored on device readable medium 680 or memory within processing circuitry 670. In alternative embodiments, some or all of the functionality may be provided by processing circuitry 670 without executing instructions stored on a separate or discrete device readable medium, such as in a hard-wired manner. In any of those embodiments, whether executing instructions stored on a device readable storage medium or not, processing circuitry 670 can be configured to perform the described functionality. The benefits provided by such functionality are not limited to processing circuitry 670 alone or to other components of network node 660, but are enjoyed by network node 660 as a whole, and/or by end users and the wireless network generally.

Device readable medium 680 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 670. Device readable medium 680 may store any suitable instructions, data or information, including a computer program, software, an application including one or more of logic, rules, code, tables, etc. and/or other instructions capable of being executed by processing circuitry 670 and, utilized by network node 660. Device readable medium 680 may be used to store any calculations made by processing circuitry 670 and/or any data received via interface 690. In some embodiments, processing circuitry 670 and device readable medium 680 may be considered to be integrated.

Interface 690 is used in the wired or wireless communication of signalling and/or data between network node 660, network 606, and/or WDs 610. As illustrated, interface 690 comprises port(s)/terminal(s) 694 to send and receive data, for example to and from network 606 over a wired connection. Interface 690 also includes radio front end circuitry 692 that may be coupled to, or in certain embodiments a part of, antenna 662. Radio front end circuitry 692 comprises filters 698 and amplifiers 696. Radio front end circuitry 692 may be connected to antenna 662 and processing circuitry 670. Radio front end circuitry may be configured to condition signals communicated between antenna 662 and processing circuitry 670. Radio front end circuitry 692 may receive digital data that is to be sent out to other network nodes or WDs via a wireless connection. Radio front end circuitry 692 may convert the digital data into a radio signal having the appropriate channel and bandwidth parameters using a combination of filters 698 and/or amplifiers 696. The radio signal may then be transmitted via antenna 662. Similarly, when receiving data, antenna 662 may collect radio signals which are then converted into digital data by radio front end circuitry 692. The digital data may be passed to processing circuitry 670. In other embodiments, the interface may comprise different components and/or different combinations of components.

In certain alternative embodiments, network node 660 may not include separate radio front end circuitry 692, instead, processing circuitry 670 may comprise radio front end circuitry and may be connected to antenna 662 without separate radio front end circuitry 692. Similarly, in some embodiments, all or some of RF transceiver circuitry 672 may be considered a part of interface 690. In still other embodiments, interface 690 may include one or more ports or terminals 694, radio front end circuitry 692, and RF transceiver circuitry 672, as part of a radio unit (not shown), and interface 690 may communicate with baseband processing circuitry 674, which is part of a digital unit (not shown).

Antenna 662 may include one or more antennas, or antenna arrays, configured to send and/or receive wireless signals. Antenna 662 may be coupled to radio front end circuitry 690 and may be any type of antenna capable of transmitting and receiving data and/or signals wirelessly. In some embodiments, antenna 662 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 662 may be separate from network node 660 and may be connectable to network node 660 through an interface or port.

Antenna 662, interface 690, and/or processing circuitry 670 may be configured to perform any receiving operations and/or certain obtaining operations described herein as being performed by a network node. Any information, data and/or signals may be received from a wireless device, another network node and/or any other network equipment. Similarly, antenna 662, interface 690, and/or processing circuitry 670 may be configured to perform any transmitting operations described herein as being performed by a network node. Any information, data and/or signals may be transmitted to a wireless device, another network node and/or any other network equipment.

Power circuitry 687 may comprise, or be coupled to, power management circuitry and is configured to supply the components of network node 660 with power for performing the functionality described herein. Power circuitry 687 may receive power from power source 686. Power source 686 and/or power circuitry 687 may be configured to provide power to the various components of network node 660 in a form suitable for the respective components (e.g., at a voltage and current level needed for each respective component). Power source 686 may either be included in, or external to, power circuitry 687 and/or network node 660. For example, network node 660 may be connectable to an external power source (e.g., an electricity outlet) via an input circuitry or interface such as an electrical cable, whereby the external power source supplies power to power circuitry 687. As a further example, power source 686 may comprise a source of power in the form of a battery or battery pack which is connected to, or integrated in, power circuitry 687. The battery may provide backup power should the external power source fail. Other types of power sources, such as photovoltaic devices, may also be used.

Alternative embodiments of network node 660 may include additional components beyond those shown in FIG. 6 that may be responsible for providing certain aspects of the network node's functionality, including any of the functionality described herein and/or any functionality necessary to support the subject matter described herein. For example, network node 660 may include user interface equipment to allow input of information into network node 660 and to allow output of information from network node 660. This may allow a user to perform diagnostic, maintenance, repair, and other administrative functions for network node 660.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 610 includes antenna 611, interface 614, processing circuitry 620, device readable medium 630, user interface equipment 632, auxiliary equipment 634, power source 636 and power circuitry 637. WD 610 may include multiple sets of one or more of the illustrated components for different wireless technologies supported by WD 610, such as, for example, GSM, WCDMA, LTE, NR, WiFi, WiMAX, or Bluetooth wireless technologies, just to mention a few. These wireless technologies may be integrated into the same or different chips or set of chips as other components within WD 610.

Antenna 611 may include one or more antennas or antenna arrays, configured to send and/or receive wireless signals, and is connected to interface 614. In certain alternative embodiments, antenna 611 may be separate from WD 610 and be connectable to WD 610 through an interface or port. Antenna 611, interface 614, and/or processing circuitry 620 may be configured to perform any receiving or transmitting operations described herein as being performed by a WD. Any information, data and/or signals may be received from a network node and/or another WD. In some embodiments, radio front end circuitry and/or antenna 611 may be considered an interface.

As illustrated, interface 614 comprises radio front end circuitry 612 and antenna 611. Radio front end circuitry 612 comprise one or more filters 618 and amplifiers 616. Radio front end circuitry 614 is connected to antenna 611 and processing circuitry 620, and is configured to condition signals communicated between antenna 611 and processing circuitry 620. Radio front end circuitry 612 may be coupled to or a part of antenna 611. In some embodiments, WD 610 may not include separate radio front end circuitry 612; rather, processing circuitry 620 may comprise radio front end circuitry and may be connected to antenna 611. Similarly, in some embodiments, some or all of RF transceiver circuitry 622 may be considered a part of interface 614. Radio front end circuitry 612 may receive digital data that is to be sent out to other network nodes or WDs via a wireless connection. Radio front end circuitry 612 may convert the digital data into a radio signal having the appropriate channel and bandwidth parameters using a combination of filters 618 and/or amplifiers 616. The radio signal may then be transmitted via antenna 611. Similarly, when receiving data, antenna 611 may collect radio signals which are then converted into digital data by radio front end circuitry 612. The digital data may be passed to processing circuitry 620. In other embodiments, the interface may comprise different components and/or different combinations of components.

Processing circuitry 620 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 610 components, such as device readable medium 630, WD 610 functionality. Such functionality may include providing any of the various wireless features or benefits discussed herein. For example, processing circuitry 620 may execute instructions stored in device readable medium 630 or in memory within processing circuitry 620 to provide the functionality disclosed herein.

As illustrated, processing circuitry 620 includes one or more of RF transceiver circuitry 622, baseband processing circuitry 624, and application processing circuitry 626. In other embodiments, the processing circuitry may comprise different components and/or different combinations of components. In certain embodiments processing circuitry 620 of WD 610 may comprise a SOC. In some embodiments, RF transceiver circuitry 622, baseband processing circuitry 624, and application processing circuitry 626 may be on separate chips or sets of chips. In alternative embodiments, part or all of baseband processing circuitry 624 and application processing circuitry 626 may be combined into one chip or set of chips, and RF transceiver circuitry 622 may be on a separate chip or set of chips. In still alternative embodiments, part or all of RF transceiver circuitry 622 and baseband processing circuitry 624 may be on the same chip or set of chips, and application processing circuitry 626 may be on a separate chip or set of chips. In yet other alternative embodiments, part or all of RF transceiver circuitry 622, baseband processing circuitry 624, and application processing circuitry 626 may be combined in the same chip or set of chips. In some embodiments, RF transceiver circuitry 622 may be a part of interface 614. RF transceiver circuitry 622 may condition RF signals for processing circuitry 620.

In certain embodiments, some or all of the functionality described herein as being performed by a WD may be provided by processing circuitry 620 executing instructions stored on device readable medium 630, which in certain embodiments may be a computer-readable storage medium. In alternative embodiments, some or all of the functionality may be provided by processing circuitry 620 without executing instructions stored on a separate or discrete device readable storage medium, such as in a hard-wired manner. In any of those particular embodiments, whether executing instructions stored on a device readable storage medium or not, processing circuitry 620 can be configured to perform the described functionality. The benefits provided by such functionality are not limited to processing circuitry 620 alone or to other components of WD 610, but are enjoyed by WD 610 as a whole, and/or by end users and the wireless network generally.

Processing circuitry 620 may be configured to perform any determining, calculating, or similar operations (e.g., certain obtaining operations) described herein as being performed by a WD. These operations, as performed by processing circuitry 620, may include processing information obtained by processing circuitry 620 by, for example, converting the obtained information into other information, comparing the obtained information or converted information to information stored by WD 610, and/or performing one or more operations based on the obtained information or converted information, and as a result of said processing making a determination.

Device readable medium 630 may be operable to store a computer program, software, an application including one or more of logic, rules, code, tables, etc. and/or other instructions capable of being executed by processing circuitry 620. Device readable medium 630 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 620. In some embodiments, processing circuitry 620 and device readable medium 630 may be considered to be integrated.

User interface equipment 632 may provide components that allow for a human user to interact with WD 610. Such interaction may be of many forms, such as visual, audial, tactile, etc. User interface equipment 632 may be operable to produce output to the user and to allow the user to provide input to WD 610. The type of interaction may vary depending on the type of user interface equipment 632 installed in WD 610. For example, if WD 610 is a smart phone, the interaction may be via a touch screen; if WD 610 is a smart meter, the interaction may be through a screen that provides usage (e.g., the number of gallons used) or a speaker that provides an audible alert (e.g., if smoke is detected). User interface equipment 632 may include input interfaces, devices and circuits, and output interfaces, devices and circuits. User interface equipment 632 is configured to allow input of information into WD 610, and is connected to processing circuitry 620 to allow processing circuitry 620 to process the input information. User interface equipment 632 may include, for example, a microphone, a proximity or other sensor, keys/buttons, a touch display, one or more cameras, a USB port, or other input circuitry. User interface equipment 632 is also configured to allow output of information from WD 610, and to allow processing circuitry 620 to output information from WD 610. User interface equipment 632 may include, for example, a speaker, a display, vibrating circuitry, a USB port, a headphone interface, or other output circuitry. Using one or more input and output interfaces, devices, and circuits, of user interface equipment 632, WD 610 may communicate with end users and/or the wireless network, and allow them to benefit from the functionality described herein.

Auxiliary equipment 634 is operable to provide more specific functionality which may not be generally performed by WDs. This may comprise specialized sensors for doing measurements for various purposes, interfaces for additional types of communication such as wired communications etc. The inclusion and type of components of auxiliary equipment 634 may vary depending on the embodiment and/or scenario.

Power source 636 may, in some embodiments, be in the form of a battery or battery pack. Other types of power sources, such as an external power source (e.g., an electricity outlet), photovoltaic devices or power cells, may also be used. WD 610 may further comprise power circuitry 637 for delivering power from power source 636 to the various parts of WD 610 which need power from power source 636 to carry out any functionality described or indicated herein. Power circuitry 637 may in certain embodiments comprise power management circuitry. Power circuitry 637 may additionally or alternatively be operable to receive power from an external power source; in which case WD 610 may be connectable to the external power source (such as an electricity outlet) via input circuitry or an interface such as an electrical power cable. Power circuitry 637 may also in certain embodiments be operable to deliver power from an external power source to power source 636. This may be, for example, for the charging of power source 636. Power circuitry 637 may perform any formatting, converting, or other modification to the power from power source 636 to make the power suitable for the respective components of WD 610 to which power is supplied.

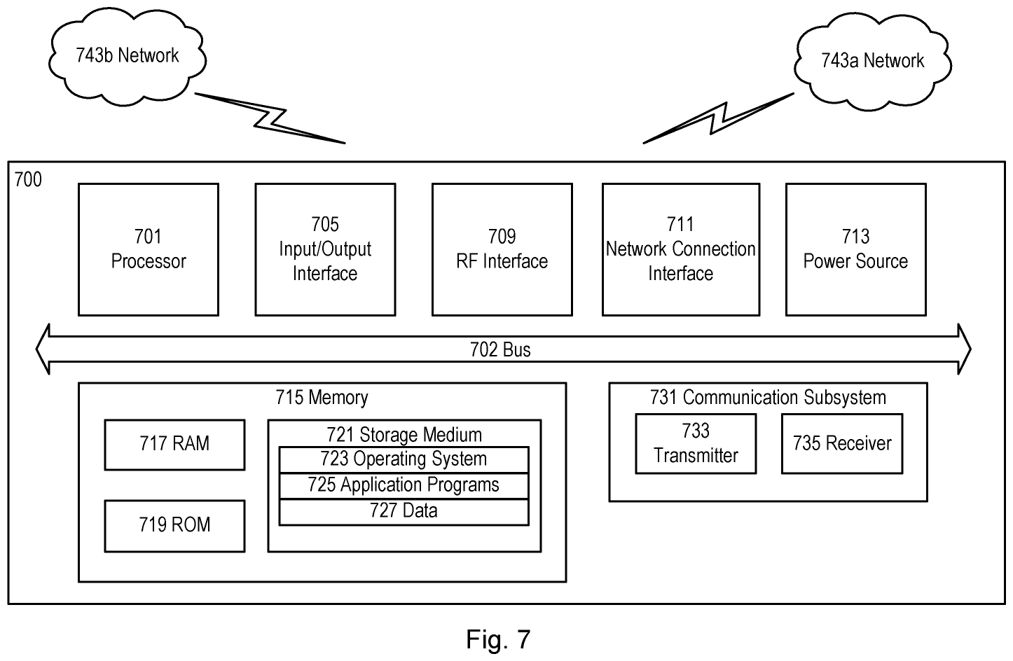

FIG. 7 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 700 may be any UE identified by the 3^{rd} Generation Partnership Project (3GPP), including a NB-IoT UE, a machine type communication (MTC) UE, and/or an enhanced MTC (eMTC) UE. UE 700, as illustrated in FIG. 7, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 7 is a UE, the components discussed herein are equally applicable to a WD, and vice-versa.

In FIG. 7, UE 700 includes processing circuitry 701 that is operatively coupled to input/output interface 705, radio frequency (RF) interface 709, network connection interface 711, memory 715 including random access memory (RAM) 717, read-only memory (ROM) 719, and storage medium 721 or the like, communication subsystem 731, power source 733, and/or any other component, or any combination thereof. Storage medium 721 includes operating system 723, application program 725, and data 727. In other embodiments, storage medium 721 may include other similar types of information. Certain UEs may utilize all of the components shown in FIG. 7, or only a subset of the components. The level of integration between the components may vary from one UE to another UE. Further, certain UEs may contain multiple instances of a component, such as multiple processors, memories, transceivers, transmitters, receivers, etc.

In FIG. 7, processing circuitry 701 may be configured to process computer instructions and data. Processing circuitry 701 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 701 may include two central processing units (CPUs). Data may be information in a form suitable for use by a computer.

In the depicted embodiment, input/output interface 705 may be configured to provide a communication interface to an input device, output device, or input and output device. UE 700 may be configured to use an output device via input/output interface 705. An output device may use the same type of interface port as an input device. For example, a USB port may be used to provide input to and output from UE 700. The output device may be a speaker, a sound card, a video card, a display, a monitor, a printer, an actuator, an emitter, a smartcard, another output device, or any combination thereof. UE 700 may be configured to use an input device via input/output interface 705 to allow a user to capture information into UE 700. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 7, RF interface 709 may be configured to provide a communication interface to RF components such as a transmitter, a receiver, and an antenna. Network connection interface 711 may be configured to provide a communication interface to network 743a. Network 743a may encompass wired and/or wireless networks such as a local-area network (LAN), a wide-area network (WAN), a computer network, a wireless network, a telecommunications network, another like network or any combination thereof. For example, network 743a may comprise a Wi-Fi network. Network connection interface 711 may be configured to include a receiver and a transmitter interface used to communicate with one or more other devices over a communication network according to one or more communication protocols, such as Ethernet, TCP/IP, SONET, ATM, or the like. Network connection interface 711 may implement receiver and transmitter functionality appropriate to the communication network links (e.g., optical, electrical, and the like). The transmitter and receiver functions may share circuit components, software or firmware, or alternatively may be implemented separately.

RAM 717 may be configured to interface via bus 702 to processing circuitry 701 to provide storage or caching of data or computer instructions during the execution of software programs such as the operating system, application programs, and device drivers. ROM 719 may be configured to provide computer instructions or data to processing circuitry 701. For example, ROM 719 may be configured to store invariant low-level system code or data for basic system functions such as basic input and output (I/O), startup, or reception of keystrokes from a keyboard that are stored in a non-volatile memory. Storage medium 721 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 721 may be configured to include operating system 723, application program 725 such as a web browser application, a widget or gadget engine or another application, and data file 727. Storage medium 721 may store, for use by UE 700, any of a variety of various operating systems or combinations of operating systems.

Storage medium 721 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 721 may allow UE 700 to access computer-executable instructions, application programs or the like, stored on transitory or non-transitory memory media, to off-load data, or to upload data. An article of manufacture, such as one utilizing a communication system may be tangibly embodied in storage medium 721, which may comprise a device readable medium.

In FIG. 7, processing circuitry 701 may be configured to communicate with network 743b using communication subsystem 731. Network 743a and network 743b may be the same network or networks or different network or networks. Communication subsystem 731 may be configured to include one or more transceivers used to communicate with network 743b. For example, communication subsystem 731 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 733 and/or receiver 735 to implement transmitter or receiver functionality, respectively, appropriate to the RAN links (e.g., frequency allocations and the like). Further, transmitter 733 and receiver 735 of each transceiver may share circuit components, software or firmware, or alternatively may be implemented separately.

In the illustrated embodiment, the communication functions of communication subsystem 731 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 731 may include cellular communication, Wi-Fi communication, Bluetooth communication, and GPS communication. Network 743b may encompass wired and/or wireless networks such as a local-area network (LAN), a wide-area network (WAN), a computer network, a wireless network, a telecommunications network, another like network or any combination thereof. For example, network 743b may be a cellular network, a Wi-Fi network, and/or a near-field network. Power source 713 may be configured to provide alternating current (AC) or direct current (DC) power to components of UE 700.

The features, benefits and/or functions described herein may be implemented in one of the components of UE 700 or partitioned across multiple components of UE 700. Further, the features, benefits, and/or functions described herein may be implemented in any combination of hardware, software or firmware. In one example, communication subsystem 731 may be configured to include any of the components described herein. Further, processing circuitry 701 may be configured to communicate with any of such components over bus 702. In another example, any of such components may be represented by program instructions stored in memory that when executed by processing circuitry 701 perform the corresponding functions described herein. In another example, the functionality of any of such components may be partitioned between processing circuitry 701 and communication subsystem 731. In another example, the non-computationally intensive functions of any of such components may be implemented in software or firmware and the computationally intensive functions may be implemented in hardware.

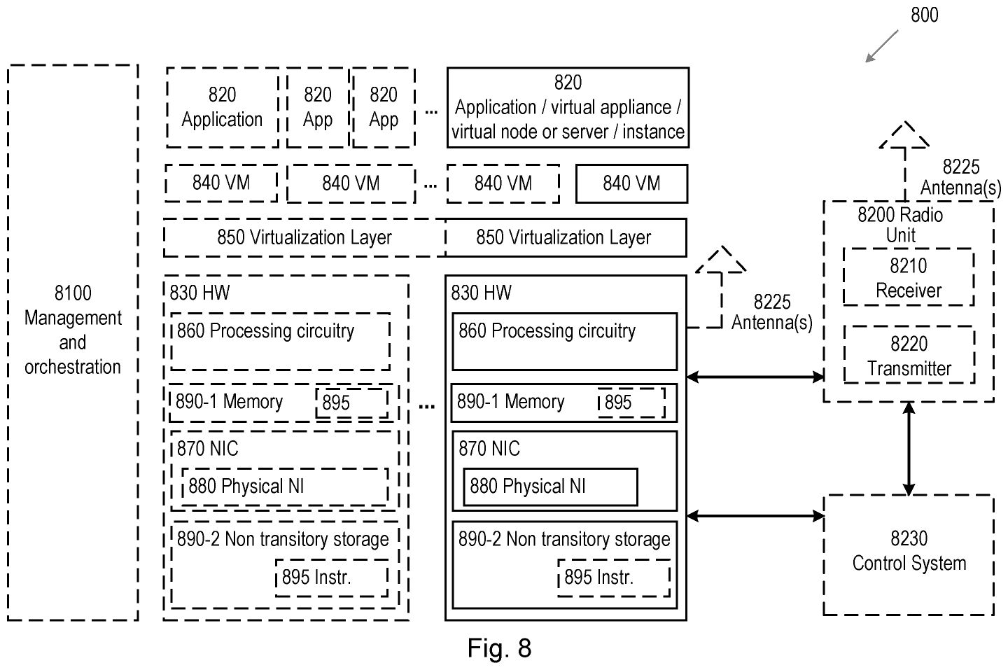

FIG. 8 is a schematic block diagram illustrating a virtualization environment 800 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 800 hosted by one or more of hardware nodes 830. Further, in embodiments in which the virtual node is not a radio access node or does not require radio connectivity (e.g., a core network node), then the network node may be entirely virtualized.

The functions may be implemented by one or more applications 820 (which may alternatively be called software instances, virtual appliances, network functions, virtual nodes, virtual network functions, etc.) operative to implement some of the features, functions, and/or benefits of some of the embodiments disclosed herein. Applications 820 are run in virtualization environment 800 which provides hardware 830 comprising processing circuitry 860 and memory 890. Memory 890 contains instructions 895 executable by processing circuitry 860 whereby application 820 is operative to provide one or more of the features, benefits, and/or functions disclosed herein.

Virtualization environment 800, comprises general-purpose or special-purpose network hardware devices 830 comprising a set of one or more processors or processing circuitry 860, which may be commercial off-the-shelf (COTS) processors, dedicated Application Specific Integrated Circuits (ASICs), or any other type of processing circuitry including digital or analog hardware components or special purpose processors. Each hardware device may comprise memory 890-1 which may be non-persistent memory for temporarily storing instructions 895 or software executed by processing circuitry 860. Each hardware device may comprise one or more network interface controllers (NICs) 870, also known as network interface cards, which include physical network interface 880. Each hardware device may also include non-transitory, persistent, machine-readable storage media 890-2 having stored therein software 895 and/or instructions executable by processing circuitry 860. Software 895 may include any type of software including software for instantiating one or more virtualization layers 850 (also referred to as hypervisors), software to execute virtual machines 840 as well as software allowing it to execute functions, features and/or benefits described in relation with some embodiments described herein.

Virtual machines 840, comprise virtual processing, virtual memory, virtual networking or interface and virtual storage, and may be run by a corresponding virtualization layer 850 or hypervisor. Different embodiments of the instance of virtual appliance 820 may be implemented on one or more of virtual machines 840, and the implementations may be made in different ways.

During operation, processing circuitry 860 executes software 895 to instantiate the hypervisor or virtualization layer 850, which may sometimes be referred to as a virtual machine monitor (VMM). Virtualization layer 850 may present a virtual operating platform that appears like networking hardware to virtual machine 840.

As shown in FIG. 8, hardware 830 may be a standalone network node with generic or specific components. Hardware 830 may comprise antenna 8225 and may implement some functions via virtualization. Alternatively, hardware 830 may be part of a larger cluster of hardware (e.g. such as in a data center or customer premise equipment (CPE)) where many hardware nodes work together and are managed via management and orchestration (MANO) 8100, which, among others, oversees lifecycle management of applications 820.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 840 may be a software implementation of a physical machine that runs programs as if they were executing on a physical, non-virtualized machine. Each of virtual machines 840, and that part of hardware 830 that executes that virtual machine, be it hardware dedicated to that virtual machine and/or hardware shared by that virtual machine with others of the virtual machines 840, forms a separate virtual network elements (VNE).

Still in the context of NFV, Virtual Network Function (VNF) is responsible for handling specific network functions that run in one or more virtual machines 840 on top of hardware networking infrastructure 830 and corresponds to application 820 in FIG. 8.

In some embodiments, one or more radio units 8200 that each include one or more transmitters 8220 and one or more receivers 8210 may be coupled to one or more antennas 8225. Radio units 8200 may communicate directly with hardware nodes 830 via one or more appropriate network interfaces and may be used in combination with the virtual components to provide a virtual node with radio capabilities, such as a radio access node or a base station.

In some embodiments, some signalling can be effected with the use of control system 8230 which may alternatively be used for communication between the hardware nodes 830 and radio units 8200.

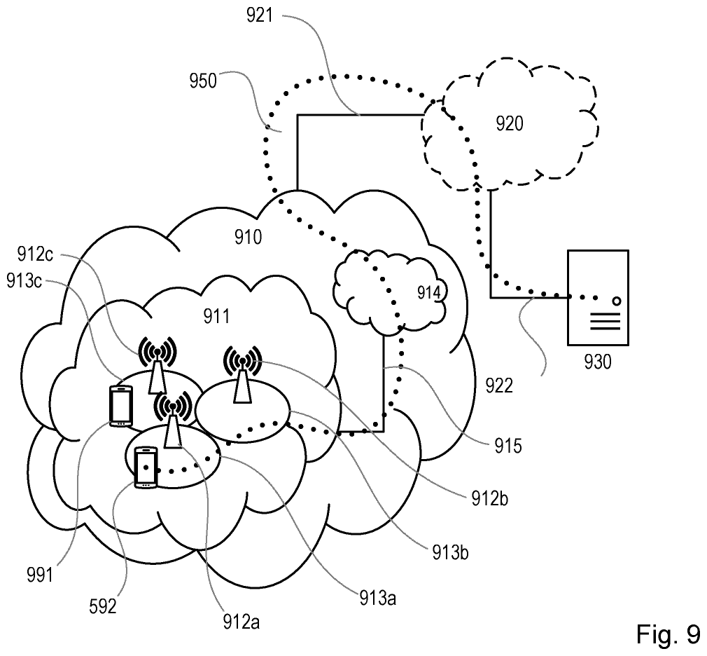

With reference to FIG. 9, in accordance with an embodiment, a communication system includes telecommunication network 910, such as a 3GPP-type cellular network, which comprises access network 911, such as a radio access network, and core network 914. Access network 911 comprises a plurality of base stations 912a, 912b, 912c, such as NBs, eNBs, gNBs or other types of wireless access points, each defining a corresponding coverage area 913a, 913b, 913c. Each base station 912a, 912b, 912c is connectable to core network 914 over a wired or wireless connection 915. A first UE 991 located in coverage area 913c is configured to wirelessly connect to, or be paged by, the corresponding base station 912c. A second UE 992 in coverage area 913a is wirelessly connectable to the corresponding base station 912a. While a plurality of UEs 991, 992 are illustrated in this example, the disclosed embodiments are equally applicable to a situation where a sole UE is in the coverage area or where a sole UE is connecting to the corresponding base station 912.

Telecommunication network 910 is itself connected to host computer 930, which may be embodied in the hardware and/or software of a standalone server, a cloud-implemented server, a distributed server or as processing resources in a server farm. Host computer 930 may be under the ownership or control of a service provider, or may be operated by the service provider or on behalf of the service provider. Connections 921 and 922 between telecommunication network 910 and host computer 930 may extend directly from core network 914 to host computer 930 or may go via an optional intermediate network 920. Intermediate network 920 may be one of, or a combination of more than one of, a public, private or hosted network; intermediate network 920, if any, may be a backbone network or the Internet; in particular, intermediate network 920 may comprise two or more sub-networks (not shown).

The communication system of FIG. 9 as a whole enables connectivity between the connected UEs 991, 992 and host computer 930. The connectivity may be described as an over-the-top (OTT) connection 950. Host computer 930 and the connected UEs 991, 992 are configured to communicate data and/or signaling via OTT connection 950, using access network 911, core network 914, any intermediate network 920 and possible further infrastructure (not shown) as intermediaries. OTT connection 950 may be transparent in the sense that the participating communication devices through which OTT connection 950 passes are unaware of routing of uplink and downlink communications. For example, base station 912 may not or need not be informed about the past routing of an incoming downlink communication with data originating from host computer 930 to be forwarded (e.g., handed over) to a connected UE 991. Similarly, base station 912 need not be aware of the future routing of an outgoing uplink communication originating from the UE 991 towards the host computer 930.

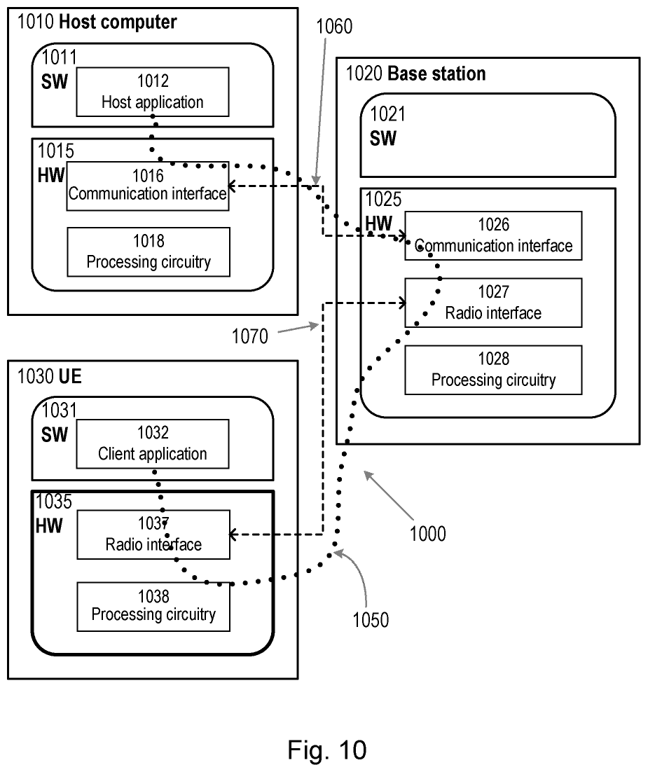

Example implementations, in accordance with an embodiment, of the UE, base station and host computer discussed in the preceding paragraphs will now be described with reference to FIG. 10. In communication system 1000, host computer 1010 comprises hardware 1015 including communication interface 1016 configured to set up and maintain a wired or wireless connection with an interface of a different communication device of communication system 1000. Host computer 1010 further comprises processing circuitry 1018, which may have storage and/or processing capabilities. In particular, processing circuitry 1018 may comprise one or more programmable processors, application-specific integrated circuits, field programmable gate arrays or combinations of these (not shown) adapted to execute instructions. Host computer 1010 further comprises software 1011, which is stored in or accessible by host computer 1010 and executable by processing circuitry 1018. Software 1011 includes host application 1012. Host application 1012 may be operable to provide a service to a remote user, such as UE 1030 connecting via OTT connection 1050 terminating at UE 1030 and host computer 1010. In providing the service to the remote user, host application 1012 may provide user data which is transmitted using OTT connection 1050.

Communication system 1000 further includes base station 1020 provided in a telecommunication system and comprising hardware 1025 enabling it to communicate with host computer 1010 and with UE 1030. Hardware 1025 may include communication interface 1026 for setting up and maintaining a wired or wireless connection with an interface of a different communication device of communication system 1000, as well as radio interface 1027 for setting up and maintaining at least wireless connection 1070 with UE 1030 located in a coverage area (not shown in FIG. 10) served by base station 1020. Communication interface 1026 may be configured to facilitate connection 1060 to host computer 1010. Connection 1060 may be direct or it may pass through a core network (not shown in FIG. 10) of the telecommunication system and/or through one or more intermediate networks outside the telecommunication system. In the embodiment shown, hardware 1025 of base station 1020 further includes processing circuitry 1028, which may comprise one or more programmable processors, application-specific integrated circuits, field programmable gate arrays or combinations of these (not shown) adapted to execute instructions. Base station 1020 further has software 1021 stored internally or accessible via an external connection.

Communication system 1000 further includes UE 1030 already referred to. Its hardware 1035 may include radio interface 1037 configured to set up and maintain wireless connection 1070 with a base station serving a coverage area in which UE 1030 is currently located. Hardware 1035 of UE 1030 further includes processing circuitry 1038, which may comprise one or more programmable processors, application-specific integrated circuits, field programmable gate arrays or combinations of these (not shown) adapted to execute instructions. UE 1030 further comprises software 1031, which is stored in or accessible by UE 1030 and executable by processing circuitry 1038. Software 1031 includes client application 1032. Client application 1032 may be operable to provide a service to a human or non-human user via UE 1030, with the support of host computer 1010. In host computer 1010, an executing host application 1012 may communicate with the executing client application 1032 via OTT connection 1050 terminating at UE 1030 and host computer 1010. In providing the service to the user, client application 1032 may receive request data from host application 1012 and provide user data in response to the request data. OTT connection 1050 may transfer both the request data and the user data. Client application 1032 may interact with the user to generate the user data that it provides.

It is noted that host computer 1010, base station 1020 and UE 1030 illustrated in FIG. 10 may be similar or identical to host computer 930, one of base stations 912a, 912b, 912c and one of UEs 991, 992 of FIG. 9, respectively. This is to say, the inner workings of these entities may be as shown in FIG. 10 and independently, the surrounding network topology may be that of FIG. 9.

In FIG. 10, OTT connection 1050 has been drawn abstractly to illustrate the communication between host computer 1010 and UE 1030 via base station 1020, without explicit reference to any intermediary devices and the precise routing of messages via these devices. Network infrastructure may determine the routing, which it may be configured to hide from UE 1030 or from the service provider operating host computer 1010, or both. While OTT connection 1050 is active, the network infrastructure may further take decisions by which it dynamically changes the routing (e.g., on the basis of load balancing consideration or reconfiguration of the network).

Wireless connection 1070 between UE 1030 and base station 1020 is in accordance with the teachings of the embodiments described throughout this disclosure. One or more of the various embodiments improve the performance of OTT services provided to UE 1030 using OTT connection 1050, in which wireless connection 1070 forms the last segment. More precisely, the teachings of these embodiments may improve the latency and data rate (e.g., by enabling the network to take one or more mitigation actions and so reduce the likelihood of further LBT failures) and thereby provide benefits such as reduced user waiting time and better responsiveness.

A measurement procedure may be provided for the purpose of monitoring data rate, latency and other factors on which the one or more embodiments improve. There may further be an optional network functionality for reconfiguring OTT connection 1050 between host computer 1010 and UE 1030, in response to variations in the measurement results. The measurement procedure and/or the network functionality for reconfiguring OTT connection 1050 may be implemented in software 1011 and hardware 1015 of host computer 1010 or in software 1031 and hardware 1035 of UE 1030, or both. In embodiments, sensors (not shown) may be deployed in or in association with communication devices through which OTT connection 1050 passes; the sensors may participate in the measurement procedure by supplying values of the monitored quantities exemplified above, or supplying values of other physical quantities from which software 1011, 1031 may compute or estimate the monitored quantities. The reconfiguring of OTT connection 1050 may include message format, retransmission settings, preferred routing etc.; the reconfiguring need not affect base station 1020, and it may be unknown or imperceptible to base station 1020. Such procedures and functionalities may be known and practiced in the art. In certain embodiments, measurements may involve proprietary UE signaling facilitating host computer 1010's measurements of throughput, propagation times, latency and the like. The measurements may be implemented in that software 1011 and 1031 causes messages to be transmitted, in particular empty or ‘dummy’ messages, using OTT connection 1050 while it monitors propagation times, errors etc.

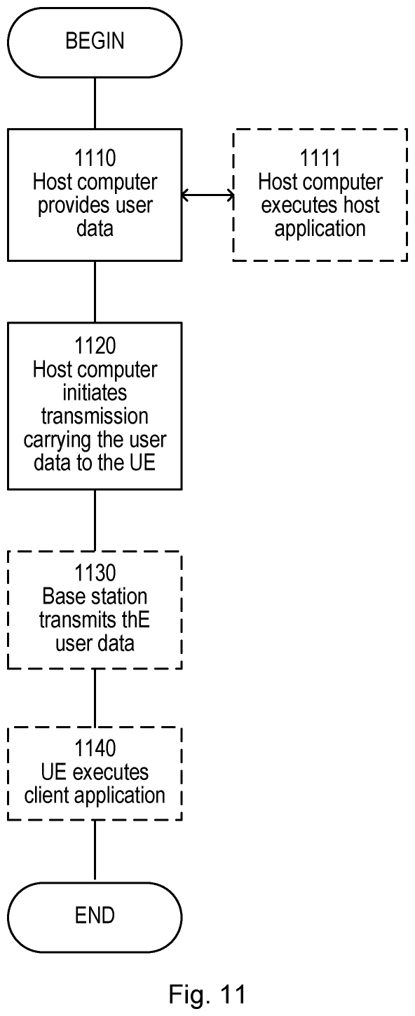

FIG. 11 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 11 will be included in this section. In step 1110, the host computer provides user data. In substep 1111 (which may be optional) of step 1110, the host computer provides the user data by executing a host application. In step 1120, the host computer initiates a transmission carrying the user data to the UE. In step 1130 (which may be optional), the base station transmits to the UE the user data which was carried in the transmission that the host computer initiated, in accordance with the teachings of the embodiments described throughout this disclosure. In step 1140 (which may also be optional), the UE executes a client application associated with the host application executed by the host computer.

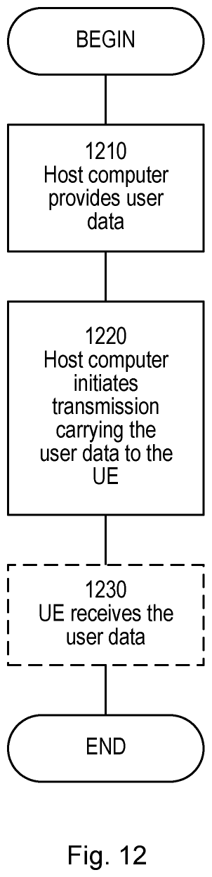

FIG. 12 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 12 will be included in this section. In step 1210 of the method, the host computer provides user data. In an optional substep (not shown) the host computer provides the user data by executing a host application. In step 1220, the host computer initiates a transmission carrying the user data to the UE. The transmission may pass via the base station, in accordance with the teachings of the embodiments described throughout this disclosure. In step 1230 (which may be optional), the UE receives the user data carried in the transmission.

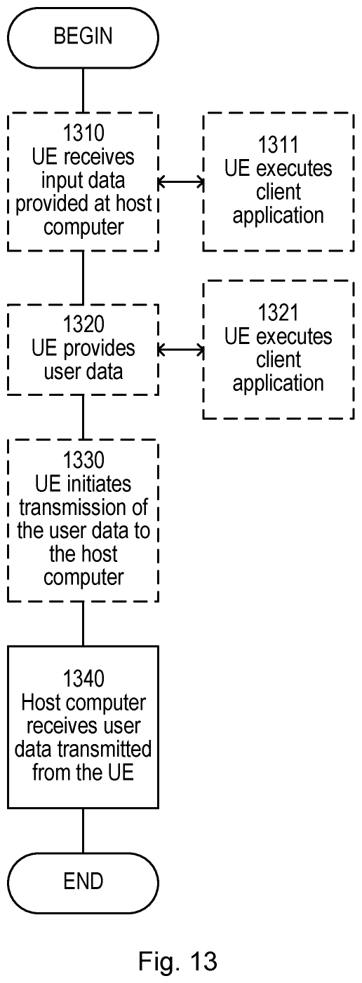

FIG. 13 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 13 will be included in this section. In step 1310 (which may be optional), the UE receives input data provided by the host computer. Additionally or alternatively, in step 1320, the UE provides user data. In substep 1321 (which may be optional) of step 1320, the UE provides the user data by executing a client application. In substep 1311 (which may be optional) of step 1310, the UE executes a client application which provides the user data in reaction to the received input data provided by the host computer. In providing the user data, the executed client application may further consider user input received from the user. Regardless of the specific manner in which the user data was provided, the UE initiates, in substep 1330 (which may be optional), transmission of the user data to the host computer. In step 1340 of the method, the host computer receives the user data transmitted from the UE, in accordance with the teachings of the embodiments described throughout this disclosure.

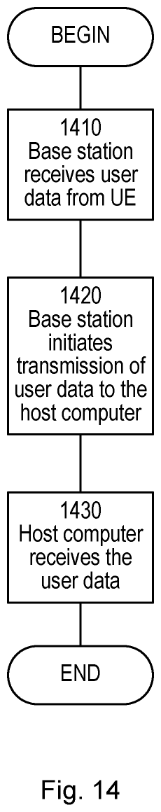

FIG. 14 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 14 will be included in this section. In step 1410 (which may be optional), in accordance with the teachings of the embodiments described throughout this disclosure, the base station receives user data from the UE. In step 1420 (which may be optional), the base station initiates transmission of the received user data to the host computer. In step 1430 (which may be optional), the host computer receives the user data carried in the transmission initiated by the base station.

For the avoidance of doubt, the following numbered statements set out embodiments of the disclosure:
1. A method performed by a wireless device, the method comprising:
   detecting one or more Listen-Before-Talk, LBT, failures, and
   transmitting, to a network node, a report message comprising an indication of the one or more LBT failures.
2. The method of embodiment 1, wherein detecting the one or more LBT failures comprises detecting a consistent LBT failure experienced by the wireless device.
3. The method of embodiment 2, wherein the consistent LBT failure is determined (by the wireless device) by detecting a maximum number of LBT failures.
4. The method of embodiment 2, wherein the consecutive LBT failure is determined (by the wireless device) by detecting the maximum number of LBT failures within a defined time window or period.
5. The method of any preceding embodiment, wherein the indication of one or more LBT failures relates to a particular portion or part of the bandwidth of a carrier configured for the wireless device.
6. The method of any preceding embodiment, wherein the report message comprises respective indications of one or more LBT failures experienced by the wireless device for a plurality of portions or parts of the bandwidth of a carrier configured for the wireless device.
7. The method of any preceding embodiment, wherein the indication of one or more LBT failures relates to one or more of: a particular cell; a particular carrier; a particular channel; a particular frequency subband; a particular public land mobile network, PLMN; a particular type of LBT; a particular channel access priority class, CAPC; a particular transmission direction, e.g. UL or DL; a particular service accessed by the wireless device; a particular logical channel; and a particular logical channel group.
8. The method of any preceding embodiment, wherein the indication of one or more LBT failures relates to a particular cell, and wherein the particular cell is not served by the network node.
9. The method of any preceding embodiment, wherein transmission of the report message is triggered periodically.
10. The method of any preceding embodiment, wherein transmission of the report message is triggered upon detection of an event by the wireless device.
11. The method of embodiment 10, wherein the event is one or more of: a threshold number of LBT failures occurring within a time period; and a channel occupancy exceeding a threshold.
12. The method of embodiment 10 or 11, wherein the report message further comprises an indication of the event which triggered transmission of the report message.
13. The method of any preceding embodiment, wherein the report message is transmitted using resources dedicated for the purposes of reporting LBT failures.
14. The method of embodiment 13, wherein the dedicated resources comprise one or more of: frequency resources; time resources; random access preamble resources; PUCCH format.
15. The method of embodiment 13 or 14, wherein the dedicated resources comprise dedicated physical random access channel, PRACH, resources.
16. The method of any one of embodiments 13 to 15, wherein the report message is conveyed via a random access preamble transmission or a msg1 message of a random access process.
17. The method of any one of embodiments 1 to 12, wherein the report message is comprised within a msgA message or a msg3 message of a random access process.
18. The method of any one of embodiments 1 to 14, wherein the report message is transmitted on physical uplink control channel, PUCCH, resources.
19. The method of any one of the preceding embodiments, wherein the report message comprises a Medium Access Control, MAC, Control Element, CE or a MAC subheader.
20. The method of any one of the preceding embodiments, wherein the report message comprises a Radio Resource Control, RRC, message.
21. The method of any one of the preceding embodiments, wherein the report message is transmitted together with an identifier for the wireless device.
22. The method of embodiment 21, wherein the identifier comprises a cell radio network temporary identifier, C-RNTI.
23. The method of any one of the preceding embodiments, wherein the report message further comprises an indication of LBT statistics comprising one or more of: number of LBT failures; number of LBT successes; LBT failure/success ratio; LBT failure rate.
24. The method of any one of the preceding embodiments, wherein the report message further comprises an indication of channel occupancy.
25. The method of any one of the preceding embodiments, wherein the report message further comprises an indication of a mitigation action to be taken by the network node.
26. The method of embodiment 25, wherein the mitigation action comprises one or more of the following: handover to another cell; cell activation, inactivation, addition, release or switch; bandwidth part activation, inactivation, addition, release or switch; carrier activation, inactivation, addition, release or switch; channel activation, inactivation, addition, release or switch; subband activation, inactivation, addition, release or switch; RRC connection establishment; and RRC status switch.
27. The method of any preceding embodiment, further comprising, responsive to detection of the one or more LBT failures, performing one or more of the following: switching to a different bandwidth part to that on which the LBT failures were experienced; and initiating RRC connection re-establishment with a different cell to that on which the LBT failures were experienced.
28. The method of any preceding embodiment, further comprising receiving, from a network node, a configuration message comprising a configuration for the reporting of LBT failures by the wireless device.
29. The method of any of the previous embodiments, further comprising:
   providing user data; and
   forwarding the user data to a host computer via the transmission to the base station.
30. A method performed by a base station, the method comprising:
   receiving, from a wireless device, a report message comprising an indication of one or more Listen-Before-Talk, LBT, failures experienced by the wireless device.
31. The method of embodiment 30, wherein the indication of one or more LBT failures comprises an indication of consistent LBT failure experienced by the wireless device.
32. The method of embodiment 31, wherein consistent LBT failure is determined by the wireless device detecting a maximum number of LBT failures.
33. The method of embodiment 32, wherein consecutive LBT failures in the maximum number of LBT failures are detected within a defined time window of each other.
34. The method of any one of embodiments 30 to 33, wherein the indication of one or more LBT failures relates to a particular portion or part of the bandwidth of a carrier configured for the wireless device.
35. The method of any one of embodiments 30 to 34, wherein the report message comprises respective indications of one or more LBT failures experienced by the wireless device for a plurality of portions or parts of the bandwidth of a carrier configured for the wireless device.
36. The method of any one of embodiments 30 to 35, wherein the indication of one or more LBT failures relates to one or more of: a particular cell; a particular carrier; a particular channel; a particular frequency subband; a particular public land mobile network, PLMN; a particular type of LBT; a particular channel access priority class, CAPC; a particular transmission direction, e.g. UL or DL; a particular service accessed by the wireless device; a particular logical channel; and a particular logical channel group.
37. The method of any one of embodiments 30 to 36, wherein the indication of one or more LBT failures relates to a particular cell, and wherein the particular cell is not served by the base station.
38. The method of any one of embodiments 30 to 37, wherein transmission of the report message is triggered periodically.
39. The method of any one of embodiments 30 to 38, wherein transmission of the report message is triggered upon detection of an event by the wireless device.
40. The method of embodiment 39, wherein the event is one or more of: a threshold number of LBT failures occurring within a time period; and a channel occupancy exceeding a threshold.
41. The method of embodiment 39 or 40, wherein the report message further comprises an indication of the event which triggered transmission of the report message.
42. The method of any one of embodiments 30 to 41, wherein the report message is received on resources dedicated for the purposes of reporting LBT failures.
43. The method of embodiment 42, wherein the dedicated resources comprise one or more of: frequency resources; time resources; random access preamble resources; PUCCH format.
44. The method of embodiment 42 or 43, wherein the dedicated resources comprise dedicated physical random access channel, PRACH, resources.
45. The method of any one of embodiments 42 to 44, wherein the report message is conveyed via a random access preamble transmission or a msg1 message of a random access process.
46. The method of any one of embodiments 30 to 41, wherein the report message is comprised within a msgA message or a msg3 message of a random access process.
47. The method of any one of embodiments 30 to 43, wherein the report message is transmitted on physical uplink control channel, PUCCH, resources.
48. The method of any one of embodiments 30 to 47, wherein the report message comprises a Medium Access Control, MAC, Control Element, CE or a MAC subheader.
49. The method of any one of embodiments 30 to 48, wherein the report message comprises a Radio Resource Control, RRC, message.
50. The method of any one of embodiments 30 to 49, wherein the report message is received together with an identifier for the wireless device.
51. The method of embodiment 50, wherein the identifier comprises a cell radio network temporary identifier, C-RNTI.
52. The method of any one of embodiments 30 to 51, wherein the report message further comprises an indication of LBT statistics comprising one or more of: number of LBT failures; number of LBT successes; LBT failure/success ratio; LBT failure rate.
53. The method of any one of embodiments 30 to 52, wherein the report message further comprises an indication of channel occupancy.
54. The method of any one of embodiments 30 to 53, wherein the report message further comprises an indication of a mitigation action to be initiated by the base station.
55. The method of embodiment 54, wherein the mitigation action comprises one or more of the following: handover to another cell; cell activation, inactivation, addition, release or switch; bandwidth part activation, inactivation, addition, release or switch; carrier activation, inactivation, addition, release or switch; channel activation, inactivation, addition, release or switch; subband activation, inactivation, addition, release or switch; RRC connection establishment; and RRC status switch.
56. The method of any one of embodiments 30 to 55, further comprising transmitting, to the wireless device, a configuration message comprising a configuration for reporting LBT failures by the wireless device.
57. The method of any one of embodiments 30 to 56, further comprising transmitting, to one or more network nodes, an indication of the one or more LBT failures detected by the wireless device.
58. The method of any one of embodiments 30 to 57, further comprising, responsive to receipt of the report message, initiating a mitigation action.
59. The method of embodiment 58, wherein the mitigation action comprises one or more of the following: handover of the wireless device to one or more other cells; switch of the wireless device to one or more other BWPs; switch of the wireless device from one serving carrier to one or more other carriers; switch of the wireless device from one serving channel or subband to one or more other channels or subbands; reconfiguration of one or more RAN functions such as PUCCH configuration, PDCCH configuration, RACH configuration, DRX configuration, SRS configuration, timing advance configuration or data transmission related functions; reconfiguration of radio link failure declaration or triggering conditions; change of an RRC status of the wireless device; changing a scheduling rate or a scheduling priority of the wireless device; increasing a transport block size scheduled for the wireless device in one or more UL grants; and switch of an operating band for a cell.
60. The method of embodiment 58 or 59, wherein the mitigation action is initiated for a group of wireless devices comprising the wireless device.
61. The method of embodiment 60, wherein the group of wireless devices: belong to the same serving cell; utilize the same carrier; utilize the same active bandwidth part; utilize the same channel; utilize the same subband; utilize the same beam; utilize the same group of beams; or utilize the same sector.
62. The method of embodiment 60 or 61, wherein the group of wireless devices: have the same UE category; or have the same UE capabilities.
63. The method of any one of embodiments 60 to 62, wherein the group of wireless devices: access the same or a similar service (e.g., having the same or similar quality of service requirements).
64. The method of any one of embodiments 60 to 63, wherein the group of wireless devices: have similar traffic pattern or characteristics.
65. The method of any one of embodiments 60 to 64, wherein the group of wireless devices: have sent an LBT/CO statistics report indicating high channel occupancy or high LBT failure rate.
66. The method of any one of embodiments 60 to 65, wherein the group of wireless devices: have failed to transmit data on one or more allocated UL grants.
67. The method of any of the previous embodiments, further comprising:
   obtaining user data; and
   forwarding the user data to a host computer or a wireless device.
68. A wireless device, the wireless device comprising:
   processing circuitry configured to perform any of the steps of any of the Group A embodiments; and
   power supply circuitry configured to supply power to the wireless device.
69. A base station, the base station comprising:
   processing circuitry configured to perform any of the steps of any of the Group B embodiments;
   power supply circuitry configured to supply power to the base station.
70. A user equipment (UE), the UE comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
71. A communication system including a host computer comprising:
   processing circuitry configured to provide user data; and
   a communication interface configured to forward the user data to a cellular network for transmission to a user equipment (UE),
   wherein the cellular network comprises a base station having a radio interface and processing circuitry, the base station's processing circuitry configured to perform any of the steps of any of the Group B embodiments.
72. The communication system of the previous embodiment further including the base station.
73. The communication system of the previous 2 embodiments, further including the UE, wherein the UE is configured to communicate with the base station.
74. The communication system of the previous 3 embodiments, wherein:
   the processing circuitry of the host computer is configured to execute a host application, thereby providing the user data; and
   the UE comprises processing circuitry configured to execute a client application associated with the host application.
75. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the base station performs any of the steps of any of the Group B embodiments.
76. The method of the previous embodiment, further comprising, at the base station, transmitting the user data.
77. The method of the previous 2 embodiments, wherein the user data is provided at the host computer by executing a host application, the method further comprising, at the UE, executing a client application associated with the host application.
78. A user equipment (UE) configured to communicate with a base station, the UE comprising a radio interface and processing circuitry configured to performs the of the previous 3 embodiments.
79. A communication system including a host computer comprising:
   processing circuitry configured to provide user data; and
   a communication interface configured to forward user data to a cellular network for transmission to a user equipment (UE),
   wherein the UE comprises a radio interface and processing circuitry, the UE's components configured to perform any of the steps of any of the Group A embodiments.
80. The communication system of the previous embodiment, wherein the cellular network further includes a base station configured to communicate with the UE.
81. The communication system of the previous 2 embodiments, wherein:
   the processing circuitry of the host computer is configured to execute a host application, thereby providing the user data; and
   the UE's processing circuitry is configured to execute a client application associated with the host application.
82. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the UE performs any of the steps of any of the Group A embodiments.
83. The method of the previous embodiment, further comprising at the UE, receiving the user data from the base station.
84. A communication system including a host computer comprising:
   communication interface configured to receive user data originating from a transmission from a user equipment (UE) to a base station,
   wherein the UE comprises a radio interface and processing circuitry, the UE's processing circuitry configured to perform any of the steps of any of the Group A embodiments.
85. The communication system of the previous embodiment, further including the UE.
86. The communication system of the previous 2 embodiments, further including the base station, wherein the base station comprises a radio interface configured to communicate with the UE and a communication interface configured to forward to the host computer the user data carried by a transmission from the UE to the base station.
87. The communication system of the previous 3 embodiments, wherein:
   the processing circuitry of the host computer is configured to execute a host application; and
   the UE's processing circuitry is configured to execute a client application associated with the host application, thereby providing the user data.
88. The communication system of the previous 4 embodiments, wherein:
   the processing circuitry of the host computer is configured to execute a host application, thereby providing request data; and
   the UE's processing circuitry is configured to execute a client application associated with the host application, thereby providing the user data in response to the request data.
89. A method implemented in a communication system including a host computer, a base station and a user equipment (UE), the method comprising:
   at the host computer, receiving user data transmitted to the base station from the UE, wherein the UE performs any of the steps of any of the Group A embodiments.
90. The method of the previous embodiment, further comprising, at the UE, providing the user data to the base station.
91. The method of the previous 2 embodiments, further comprising:
   at the UE, executing a client application, thereby providing the user data to be transmitted; and
   at the host computer, executing a host application associated with the client application.
92. The method of the previous 3 embodiments, further comprising:
   at the UE, executing a client application; and
   at the UE, receiving input data to the client application, the input data being provided at the host computer by executing a host application associated with the client application,
   wherein the user data to be transmitted is provided by the client application in response to the input data.
93. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.
94. The communication system of the previous embodiment further including the base station.
95. The communication system of the previous 2 embodiments, further including the UE, wherein the UE is configured to communicate with the base station.
96. The communication system of the previous 3 embodiments, wherein:
   the processing circuitry of the host computer is configured to execute a host application;
   the UE is configured to execute a client application associated with the host application, thereby providing the user data to be received by the host computer.
97. A method implemented in a communication system including a host computer, a base station and a user equipment (UE), the method comprising:
   at the host computer, receiving, from the base station, user data originating from a transmission which the base station has received from the UE, wherein the UE performs any of the steps of any of the Group A embodiments.
98. The method of the previous embodiment, further comprising at the base station, receiving the user data from the UE.
99. The method of the previous 2 embodiments, further comprising at the base station, initiating a transmission of the received user data to the host computer.

### APPENDIX

### Introduction

For operation in unlicensed spectrum, LBT-operation may be applied prior to any transmission. Due to LBT failures in DL transmissions, a UE may miss the reception of RLM RSs. Due to LBT failures in UL transmissions, a UE may not be able to perform an uplink transmission in time. For either of reasons, additional latency may be incurred for the UE to be able to detect an RLF in time. Therefore, we may need to take the impact of LBT failures into account and make necessary enhancements to the existing RLM/RLF procedure for NR-U.

In RAN2#107, RAN2 has made below agreements regarding UL LBT failure handling.
L2 LBT failure mechanism take into account any LBT failure regardless UL transmission type.
The UL LBT failure mechanism will have the same recovery mechanism for all failures regardless UL transmission type
UL LBT failures are detected per BWP
The UE will report the occurrence of consistent UL LBT failures on PSCell and SCells. The assumption is to reuse SCell failure reporting for BF
Baseline Mechanism, further enhancements not precluded:
A “threshold” for the maximum number of LBT failures which triggers the “consistent” LBT failure event will be used.
Both a timer and a counter are introduced, the counter is reset when timer expires and incremented when UL LBT failure happens
The timer is started/restarted when UL LBT failure occur.

From above agreements, it is observed that a BFD like mechanism is used as the baseline for detection of consistent UL LBT failures. One remaining issue for detection of UL LBT failures is to define detailed detection procedure.

In addition, RAN2 has also agreed to maintain UL LBT failure handling per BWP. The detection and recovery procedure are also performed for SCells. These agreements are related to recovery actions. RAN2 need to further define details.

In this paper we discuss the above remaining issues by incorporating the above RAN2 agreements. The discussions focus on the UL transmissions and the DL transmissions.

### DISCUSSIONS

### Detection of UL LBT Failures

In RAN2#107, the BFD like mechanism has been agreed as the baseline for detection of UL LBT failures. The BFD procedure has been defined in NR Rel-15. It would reduce the work efforts for RAN2 to design detection mechanism for UL LBT failures on top of the BFD procedure. As expressed by other companies, there may be some other issues which can lead to further enhancements. They can be left to be studied in future releases.

Therefore, we make the below proposal.
Proposal 1 The agreed baseline mechanism for how to detect UL LBT failure is sufficient in Rel-16. Further enhancements can be left for future releases.

### Recovery Actions Upon Detection of UL LBT Failures

RAN2 has agreed to maintain the procedure per BWP. The UE may be configured with several BWPs, UL LBT failure handling should be operated per BWP, since different BWP may have different state of channel occupancy.

### Observation 1 UL LBT Failure Handling is Maintained Per BWP.

The UE shall maintain a timer and a counter for every BWP. Whenever the UE switches to a different BWP. The UE shall use the timer and the counter in the new active BWP for detection of UL LBT failures. At the same time, it is reasonable to reset the timer and the counter in the de-activated BWP.
Proposal 2 The counter and the timer for LBT failure handling in a de-activated BWP should be reset after a BWP switch.

If the active BWP comprises several LBT subbands, it is sufficient for the UE to keep a common counter across LBT subbands with the same BWP. In other words, an UL LBT problem is only declared in case the number of LBT failures from all LBT subbands has reached a predefined counter.
Proposal 3 The UE keeps one common counter for all LBT subbands within a BWP.

If the UE experiences LBT problems in its current active BWP, it is beneficial for the UE to switch to another BWP prior to triggering of a RLF. As one option, the UE may initiate a RA on an inactive BWP. If there are no PRACH occasions configured on any inactive BWP, the UE can switch to the initial BWP to start a RACH procedure.

Upon reception of the RA, the gNB can decide if the UE needs to switch to another BWP. The gNB can reply with a DCI or an RRC reconfiguration indicating the new BWP which may be a different one from which the UE has transmitted the RA in. After switching to the new active BWP, the UE can reset the counter for LBT problem detection.
Proposal 4 Upon detection of consistent UL LBT failure in an active BWP, prior to triggering of an RLF event, the UE can initiate a RA on an inactive BWP configured with PRACH occasions. If there are no PRACH occasions configured on any inactive non-initial BWP, the UE can switch to the initial BWP to start a RACH procedure.

If the UE has detected LBT problems for all configured BWPs with RA configured, the UE may declare an RLF for the cell and trigger RRC connection reestablishment.
Proposal 5 The UE declares an RLF for a cell if the UE has detected LBT problem for all configured BWPs with RA configured.

In case an RLF event is triggered, the UE would follow the existing RRC connection reestablishment procedure to recover from the failure. In LTE, after the recovery, the UE may send an RLF report for reporting occurrence of the RLF. We think such function shall be the same for NR. In the RLF report, the UE includes a failure cause indicating that the RLF was triggered due to occurrence of consistent UL LBT failures. Therefore, we make below proposal.
Proposal 6 Upon re-establishing after an RLF event, as in LTE, the UE sends an RLF report. The UE can include a failure cause in the report indicating that the RLF was triggered due to occurrence of consistent UL LBT failures.

For a UE configured with SCells, if the UE has detected consistent UL LBT failure in one carrier, the UE may inform the gNB of the occurrence of the LBT failure, so the gNB may take appropriate recovery actions, for example, to inactivate or de-configure the cell where the UL LBT failure has been detected. The signalling may be sent on a different cell (e.g., PCell or another SCell). How to send the signalling is FFS.
Proposal 7 For a UE configured with SCells, the UE indicates the occurrence of consistent UL LBT failure for an SCell to the gNB on a different cell (e.g., PCell or another SCell). How to send the signalling is FFS.

### Text Proposals

### Text Proposals in the MAC Spec

In the running MAC CR the section 5.X introduce LBT operation. This section can better be split in two parts “5.X1 General”, where LBT procedures are introduced, and “5.X.2 LBT failure detection and recovery procedure”.

### 5.X LBT Operation

### 5.X.1 General

The lower layer may perform an LBT procedure, according to which a transmission is not performed if the channel is identified as being occupied. When lower layer performs an LBT procedure before a transmission, an LBT success or an LBT failure indication is sent to the MAC entity. When LBT procedure is performed, actions related to “is transmitted” and “transmission is performed” shall not be performed if LBT failure indication is received from lower layers.
Editor's Note: This introduces LBT procedures and implements the last part of agreement “As earlier agreed, The POWER_RAMPING_COUNTER is not increased if the preamble is not transmitted due to LBT failure. For this purpose, LBT failure indication or equiv. (used for other LBT outcome dependencies) from PHY is used.”
Editor's Note: Below we expect to introduce the Consistent LBT failure handling. Now the baseline mechanism for consistent LBT failure detection is provided, further enhancements are not precluded. The details of recovery are FFS.

### 5.X.2 LBT Failure Detection and Recovery Procedure

The MAC entity may be configured by RRC with a consistent LBT failure recovery procedure. Consistent LBT failure is detected by counting LBT failure indications, for all UL transmissions, from the lower layers to the MAC entity. Consistent LBT failure detection is maintained per BWP. In case UE has detected a consistent LBT failure in its active BWP, the UE switches to another BWP by initiating a Random access procedure on that BWP. If the UE has detected consistent LBT failures on all configured dedicated BWPs configured with PRACH resources, a radio link failure event is triggered.

RRC configures the following parameters in the Ibt-FailureRecoveryConfig in BWP-UplinkDedicated:
Ibt-FailureInstanceMaxCount for the consistent LBT failure detection;
Ibt-FailureDetectionTimer for the consistent LBT failure detection;

The following UE variables are used for the consistent LBT failure detection procedure:
LBT_COUNTER: counter for LBT failure indication which is initially set to 0.

The MAC entity shall:
1> if LBT failure indication has been received from lower layers:
   2> start or restart the Ibt-FailureDetectionTimer;
   2> increment LBT_COUNTER by 1;
   2> if LBT_COUNTER>=Ibt-FailureInstanceMaxCount:
      3> if the UE has detected LBT failures in all BWPs configured with PRACH occasions
         4> the UE indicates Consistent UL LBT failure to higher layers
      Editor's Note: how to capture in the RRC spec is FFS
      3> else
         4> initiate a Random Access Procedure (as specified in clause 5.1.1) in another BWP configured with PRACH occasions
      Editor's Note: how to select another BWP is FFS
1> if the Ibt-FailureDetectionTimer expires; or
1> if Ibt-FailureDetectionTimer or Ibt-FailureInstanceMaxCount is reconfigured by upper layers:
   2> set LBT_COUNTER to 0.
Proposal 8 Adopt the proposed changes in 5.X of MAC running CR.

### 5.15 Bandwidth Part (BWP) Operation

In addition to clause 12 of TS 38.213 [6], this clause specifies requirements on BWP operation.

A Serving Cell may be configured with one or multiple BWPs, and the maximum number of BWP per Serving Cell is specified in TS 38.213 [6].

The BWP switching for a Serving Cell is used to activate an inactive BWP and deactivate an active BWP at a time. The BWP switching is controlled by the PDCCH indicating a downlink assignment or an uplink grant, by the bwp-InactivityTimer, by RRC signalling, or by the MAC entity itself upon initiation of Random Access procedure.

When a BWP switch is triggered by a UE upon detection of consistent LBT failure in its active BWP, the UE can select another inactive BWP with PRACH resources configured to initiate a Random Access procedure. In case there is no other inactive dedicated BWP configured with PRACH resources, the UE switches the active UL BWP to BWP indicated by initialUplinkBWP and initiate the Random Access procedure.

Upon RRC (re-)configuration of firstActiveDownlinkBWP-Id and/or firstActiveUplinkBWP-Id for SpCell or activation of an SCell, the DL BWP and/or UL BWP indicated by firstActiveDownlinkBWP-Id and/or firstActiveUplinkBWP-Id respectively (as specified in TS 38.331 [5]) is active without receiving PDCCH indicating a downlink assignment or an uplink grant. The active BWP for a Serving Cell is indicated by either RRC or PDCCH (as specified in TS 38.213 [6]). For unpaired spectrum, a DL BWP is paired with a UL BWP, and BWP switching is common for both UL and DL.

For each activated Serving Cell configured with a BWP, the MAC entity shall:
1> if a BWP is activated:
   2> transmit on UL-SCH on the BWP;
   2> transmit on RACH on the BWP, if PRACH occasions are configured;
   2> monitor the PDCCH on the BWP;
   2> transmit PUCCH on the BWP, if configured;
   2> report CSI for the BWP;
   2> transmit SRS on the BWP, if configured;
   2> receive DL-SCH on the BWP;
   2> (re)initialize any suspended configured uplink grants of configured grant Type 1 on the active BWP according to the stored configuration, if any, and to start in the symbol according to rules in clause 5.8.2.
   2> if consistent LBT failure recovery is configured:
      3> stop the IbtFailureDetectionTimer, if running;
      3> set LBT_COUNTER to 0;
      3> monitor consistent LBT failures.
1> if a BWP is deactivated:
   2> not transmit on UL-SCH on the BWP;
   2> not transmit on RACH on the BWP;
   2> not monitor the PDCCH on the BWP;
   2> not transmit PUCCH on the BWP;
   2> not report CSI for the BWP;
   2> not transmit SRS on the BWP;
   2> not receive DL-SCH on the BWP;
   2> clear any configured downlink assignment and configured uplink grant of configured grant Type 2 on the BWP;
   2> suspend any configured uplink grant of configured grant Type 1 on the inactive BWP.
   2> not monitor consistent LBT failures.
      <non modified parts are omitted>
Proposal 9 Adopt the proposed spec changes in 5.15 on reset of the timer and the counter into the MAC running CR.

The MAC reset needs to be updated with resetting the LBT_COUNTER:

### 5.12 MAC Reset

If a reset of the MAC entity is requested by upper layers, the MAC entity shall:
1> initialize Bj for each logical channel to zero;
1> stop (if running) all timers;
1> consider all timeAlignmentTimers as expired and perform the corresponding actions in clause 5.2;
1> set the NDIs for all uplink HARQ processes to the value 0;
1> stop, if any, ongoing RACH procedure;
1> discard explicitly signalled contention-free Random Access Resources, if any;
1> flush Msg3 buffer;
1> cancel, if any, triggered Scheduling Request procedure;
1> cancel, if any, triggered Buffer Status Reporting procedure;
1> cancel, if any, triggered Power Headroom Reporting procedure;
1> flush the soft buffers for all DL HARQ processes;
1> for each DL HARQ process, consider the next received transmission for a TB as the very first transmission;
1> release, if any, Temporary C-RNTI;
1> reset BFI_COUNTER.
1> reset LBT_COUNTER.
Proposal 10 Adopt the proposed spec changes in 5.12 into the MAC running CR.

### Text Proposals in the Stage 2 Spec

### 9.2 Intra-NR

<non modified parts are omitted>

### 9.2.X UL LBT Failure Detection and Recovery

In RRC_CONNECTED, the UE monitors UL LBT failures in the active BWP for all UL transmissions including any transmission carried on RACH, SRS, PUCCH and PUSCH. If the active BWP comprises several LBT subbands, the UE maintains a common counter across LBT subbands within the same BWP. The UE may be configured with several BWPs, UL LBT failure handling should be operated per BWP.

The UE declares UL LBT problem when below criterion is met:
A maximum number of consecutive UL LBT failures has been reached while a timer is running

If the UE experiences UL LBT problem in its current active BWP, the UE initiate a Random Access procedure on an inactive BWP. If there are no PRACH occasions configured on any inactive BWP, the UE can switch to the initial BWP to start a RACH procedure. Upon reception of the Random Access procedure, the gNB can decide if the UE needs to switch to another BWP. The gNB can reply with a DCI or an RRC reconfiguration indicating the new BWP which may be a different one from which the UE has transmitted the Random Access procedure in.

If the UE has detected LBT problems for all configured BWPs, the UE may declare RLF.

For a UE configured with Carrier Aggregation, if the UE has detected UL LBT problem in one carrier, the UE may inform the gNB which may take appropriate actions, for example, to inactivate or de-configure the cell where the UL LBT problem has been detected.

For a UE configured with Dual Connectivity, the UE reports SCG LBT problem to MCG, if the UE has experienced UL LBT failures consecutively up to a maximum number in SCG.

1.-36. (canceled)

37. A method performed by a wireless device, the method comprising:
determining a consistent uplink (Listen-Before-Talk) LBT failure by detecting a maximum number of uplink LBT failures related to a particular cell;
transmitting, to a network node, a report message comprising an indication of the consistent uplink LBT failure experienced by the wireless device with respect to the particular cell;
wherein the report message comprises a Medium Access Control (MAC) Control Element (CE).

38. The method of claim 37, wherein wireless device is configured with a plurality of serving cells, the plurality of serving cells including the particular cell, and wherein the report message is transmitted to another one of the serving cells.

39. The method of claim 37, wherein the report message is transmitted together with an identifier for the wireless device, wherein the identifier comprises a cell radio network temporary identifier (C-RNTI).

40. The method of claim 37, wherein the indication of the consistent LBT failure relates to a particular portion or part of the bandwidth of a carrier configured for the wireless device.

41. The method of claim 37, wherein the report message comprises respective indications of the consistent LBT failure experienced by the wireless device for a plurality of portions or parts of the bandwidth of a carrier configured for the wireless device.

42. The method of claim 37, wherein the particular cell is not served by the network node.

43. The method of claim 37, wherein transmission of the report message is triggered periodically and/or upon detection of an event by the wireless device.

44. The method of claim 37, wherein the report message further comprises one or more of the following:
an indication of channel occupancy; and
an indication of LBT statistics, the indication of LBT statistics comprising one or more of: number of LBT failures; number of LBT successes; LBT failure/success ratio; or LBT failure rate.

45. The method of claim 37, wherein the report message further comprises an indication of a mitigation action to be taken by the network node.

46. The method of claim 37, further comprising, responsive to detection of the maximum number of LBT failures, performing one or more of the following: switching to a different bandwidth part from that on which the LBT failures were experienced; and initiating RRC connection re-establishment with a different cell from that on which the LBT failures were experienced.

47. A method performed by a base station, the method comprising:
receiving, from a wireless device, a report message comprising an indication of a consistent uplink Listen-Before-Talk (LBT) failure experienced by the wireless device with respect to a particular cell;
wherein the report message comprises a Medium Access Control (MAC) Control Element (CE).

48. The method of claim 47, wherein the report message is received together with an identifier for the wireless device, wherein the identifier comprises a cell radio network temporary identifier (C-RNTI).

49. The method of claim 47, wherein the particular cell is not served by the base station.

50. The method of claim 47, wherein the report message further comprises one or more of the following:
an indication of channel occupancy; and
an indication of LBT statistics, the indication of LBT statistics comprising one or more of: number of LBT failures; number of LBT successes; LBT failure/success ratio;
or LBT failure rate.

51. The method of claim 47, wherein the report message further comprises an indication of a mitigation action to be initiated by the base station, wherein the mitigation action comprises one or more of the following: handover to another cell; cell activation, inactivation, addition, release or switch; bandwidth part activation, inactivation, addition, release or switch; carrier activation, inactivation, addition, release or switch; channel activation, inactivation, addition, release or switch; subband activation, inactivation, addition, release or switch; RRC connection establishment; or RRC status switch.

52. The method of claim 47, further comprising one or more of the following:
transmitting, to the wireless device, a configuration message comprising a configuration for reporting LBT failures by the wireless device; and
transmitting, to one or more network nodes, an indication of the consistent uplink LBT failure detected by the wireless device.

53. The method of claim 47, further comprising, responsive to receipt of the report message, initiating a mitigation action, wherein the mitigation action comprises one or more of the following:
handover of the wireless device to one or more other cells;
switch of the wireless device to one or more other Bandwidth Parts (BWP)s;
switch of the wireless device from one serving carrier to one or more other carriers;
switch of the wireless device from one serving channel or subband to one or more other channels or subbands;
reconfiguration of one or more RAN functions including:
PUCCH configuration,
PDCCH configuration,
RACH configuration,
DRX configuration,
SRS configuration,
timing advance configuration or data transmission related functions;
reconfiguration of radio link failure declaration or triggering conditions;
change of an RRC status of the wireless device;
change of a scheduling rate or a scheduling priority of the wireless device;
increase of a transport block size scheduled for the wireless device in one or more UL grants; or
switch of an operating band for a cell.

54. A wireless device, the wireless device comprising:
processing circuitry configured to cause the wireless device to
determine a consistent uplink Listen-Before-Talk (LBT) failure by detecting a maximum number of uplink LBT failures related to a particular cell;
transmitting, to a network node, a report message comprising an indication of the consistent uplink LBT failure;
wherein the report message comprises a Medium Access Control (MAC) Control Element (CE); and
power supply circuitry configured to supply power to the wireless device.

55. A base station, the base station comprising:
processing circuitry configured to cause the base station to:
receiving, from a wireless device, a report message comprising an indication of a consistent uplink Listen-Before-Talk (LBT) failure experienced by the wireless device with respect to a particular cell;
wherein the report message comprises a Medium Access Control (MAC) Control Element (CE); and
power supply circuitry configured to supply power to the base station.
